(19) United States
(12) Patent Application Publication
(10) Pub. No.: US 2018/0033362 A1
(43) Pub. Date: Feb. 1, 2018

(54) DISPLAY METHOD, DISPLAY DEVICE, ELECTRONIC DEVICE, NON-TEMPORARY MEMORY MEDIUM, AND PROGRAM

(71) Applicant: Semiconductor Energy Laboratory Co., Ltd., Atsugi-shi (JP)

(72) Inventors: Shunpei YAMAZAKI, Tokyo (JP); Yasuhiko TAKEMURA, Isehara (JP)

(21) Appl. No.: 15/658,554

(22) Filed: Jul. 25, 2017

(30) Foreign Application Priority Data
Jul. 29, 2016 (JP) 2016-149266
Jul. 29, 2016 (JP) 2016-149267

(51) Int. Cl. G09G 3/20; G09G 3/3225; G06K 9/00; G09G 3/36

(52) U.S. Cl. CPC G09G 3/2074; G09G 3/3648; G09G 3/3225; G06K 9/00604; G09G 2354/00; G09G 2320/062; G09G 2380/14; G09G 2320/066; G06F 1/1641

(57) ABSTRACT

A display device includes a display portion where pixels including light-emitting elements are arranged in matrix and each of the pixels comprises at least a subpixel. A display method of the display device includes a step of calculating a first part watched by a user of the display device and a step of determining whether or not the first part is included in the display portion are included. In the case where the first part is included in the display portion, the gray level of first subpixels that are included in the first part is made different from the gray level of second subpixels that are included in the other part.

### TECHNICAL FIELD

One embodiment of the present invention relates to a display method, a display device, an electronic device, a non-temporary memory medium, and a program.

Note that one embodiment of the present invention is not limited to the above technical field. The technical field of one embodiment of the invention disclosed in this specification and the like relates to an object, a method, or a manufacturing method. Furthermore, one embodiment of the present invention relates to a process, a machine, manufacture, or a composition of matter. Specifically, examples of the technical field of one embodiment of the present invention disclosed in this specification and the like include a semiconductor device, a display device, a light-emitting device, a power storage device, a memory device, a method for driving any of them, and a method for manufacturing any of them.

### BACKGROUND ART

A technique is disclosed in which a user of a display device is detected and, in an image displayed on the display device, a part of the image that is not watched by the user is displayed with a low refresh rate. This enables the power consumption of the display device to be reduced (see Patent Document 1).

### REFERENCE

### Patent Document

[Patent Document 1] Japanese Published Patent Application No. 2015-125356

### DISCLOSURE OF INVENTION

Displaying a high-contrast image, i.e., a high-quality image, on the part that is not watched by a user of a display device increases the power consumption of the display device.

One object of one embodiment of the present invention is to provide a display method and a display device that can achieve low power consumption. One object of one embodiment of the present invention is to provide a display method and a display device that enable a high-quality image to be displayed. One object of one embodiment of the present invention is to provide a display method and a display device that can prevent a significant change in contrast. One object of one embodiment of the present invention is to provide a display method or a display device that can achieve high-speed operation. One object of one embodiment of the present invention is to provide a novel display method and a novel display device.

Note that the descriptions of these objects do not disturb the existence of other objects. In one embodiment of the present invention, there is no need to achieve all the objects. Objects other than the above objects will be apparent from and can be derived from the descriptions of the specification, the drawings, the claims, and the like.

One embodiment of the present invention is a display method of a display device including a display portion where first pixels including light-emitting elements are arranged in matrix. The first pixel comprises at least a subpixel. The display method includes a step of calculating a first part watched by a user of the display device and a step of determining whether or not the first part is included in the display portion. When the first part is included in the display portion, a gray level for representation of luminance of light emitted from first subpixels that are included in the first part is made different from a gray level for representation of luminance of light emitted from second subpixels that are not included in any of the first part and a part in a neighborhood of the first part.

In the above-described embodiment, a size and a shape of the part in the neighborhood of the first part may be set depending on a size and a shape of the first part.

One embodiment of the present invention is a display method of a display device including a display portion where first pixels including light-emitting elements are arranged in matrix. The first pixel comprises at least a subpixel. The display method includes a step of calculating a first part watched by a user of the display device and a step of calculating a row or a column of text included in the first part. A gray level for representation of luminance of light emitted from the subpixel provided in the row or the column of the text included in the first part is made different from a gray level for representation of luminance of light emitted from the subpixel provided in a row or a column that is not a row or a column of text included in the first part and is not a row or a column in a neighborhood of the row or the column of text included in the first part.

In the above-described embodiment, a row previous to the row of the text included in the first part and a row next to the row of the text included in the first part may be defined as rows in a neighborhood of the row of the text included in the first part.

In the above-described embodiment, a column previous to the column of the text included in the first part and a column next to the column of the text included in the first part may be defined as columns in a neighborhood of the column of the text included in the first part.

In the above-described embodiment, the display method may further include a step of detecting a pupil of a user of the display device using a sensor included in the display device.

In the above-described embodiment, the first part may be calculated using a distance between the user of the display device and the display portion.

In the above-described embodiment, the display device may include a second pixel, the second pixel may include a liquid crystal element, and the first pixel and the second pixel may be stacked.

In the above-described embodiment, the light-emitting element may be an OLED.

A display device configured to display an image by the display method of one embodiment of the present invention is also one embodiment of the present invention.

A display device including the display device of one embodiment of the present invention, a transistor, and an infrared source is also one embodiment of the present invention.

In the above-described embodiment, the transistor may include a metal oxide in a channel formation region.

An electronic device including the display device of one embodiment of the present invention and an operation button or a battery is also one embodiment of the present invention.

A non-temporary memory medium including a program configured to execute the display method of one embodiment of the present invention is also one embodiment of the present invention.

A program configured to execute the display method of one embodiment of the present invention is also one embodiment of the present invention.

One embodiment of the present invention can provide a display method and a display device that can achieve low power consumption. One embodiment of the present invention can provide a display method and a display device that enable a high-quality image to be displayed. One embodiment of the present invention can provide a display method and a display device that can prevent a significant change in contrast. One embodiment of the present invention can provide a display method or a display device that can achieve high-speed operation. One embodiment of the present invention can provide a novel display method and a novel display device.

Note that the description of these effects does not preclude the existence of other effects. One embodiment of the present invention does not necessarily achieve all the effects listed above. Other effects will be apparent from and can be derived from the description of the specification, the drawings, the claims, and the like.

### BRIEF DESCRIPTION OF DRAWINGS

FIGS. 1A to 1D are block diagrams illustrating structure examples of a display device.

FIG. 2 is a block diagram illustrating a structure example of a display device.

FIGS. 3A to 3C are schematic views illustrating structure examples of a display device.

FIG. 4 is a flow chart illustrating an example of a display method.

FIG. 5 illustrates parts of a display portion included in a display device.

FIG. 6 illustrates the case where text is displayed on a display portion included in a display device.

FIGS. 7A and 7B are schematic views illustrating structure examples of a display device.

FIG. 8 is a flow chart illustrating an example of a display method.

FIG. 9 is a cross-sectional view illustrating a structure example of a display device.

FIG. 10 is a cross-sectional view illustrating a structure example of a display device.

FIG. 11 is a cross-sectional view illustrating a structure example of a display device.

FIGS. 12A to 12C are cross-sectional view illustrating structure examples of a display device.

FIG. 13 is a cross-sectional view illustrating a structure example of a display device.

FIGS. 14A and 14B are top views illustrating structure examples of a display device.

FIG. 15 is a circuit diagram illustrating a structure example of a pixel.

FIGS. 16A and 16B are a circuit diagram and a block diagram each illustrating a structure example of a pixel.

FIG. 17 is a top view illustrating a structure example of a display device.

FIG. 18 is a cross-sectional view illustrating a structure example of a display device.

FIG. 19 is a cross-sectional view illustrating a structure example of a display device.

FIG. 20 is a cross-sectional view illustrating a structure example of a display device.

FIG. 21 is a cross-sectional view illustrating a structure example of a display device.

FIG. 22 illustrates a structure example of a display module.

FIGS. 23A and 23B illustrate electronic devices.

FIGS. 24A to 24D illustrate electronic devices.

### BEST MODE FOR CARRYING OUT THE INVENTION

Hereinafter, embodiments of the present invention will be described with reference to the accompanying drawings. Note that the embodiments of the present invention can be implemented with various modes, and it is readily appreciated by those skilled in the art that modes and details can be changed in various ways without departing from the spirit and scope of the present invention. Thus, the present invention should not be interpreted as being limited to the following description of the embodiments.

Although the block diagram attached to this specification and the like shows components classified by their functions in independent blocks, it is difficult to classify actual components according to their functions completely and it is possible for one component to have a plurality of functions.

In this specification and the like, the terms “source” and “drain” of a transistor interchange with each other depending on the polarity of the transistor or the levels of potentials applied to the terminals. In general, in an n-channel transistor, a terminal to which a lower potential is applied is called a source, and a terminal to which a higher potential is applied is called a drain. In a p-channel transistor, a terminal to which a lower potential is applied is called a drain, and a terminal to which a higher potential is applied is called a source. In this specification and the like, although the connection relationship of the transistor is described assuming that the source and the drain are fixed in some cases for convenience, actually, the names of the source and the drain interchange with each other depending on the relationship of the potentials.

In this specification and the like, the term “source” of a transistor means a source region that is part of a semiconductor film functioning as a semiconductor layer or a source electrode connected to the semiconductor film. Similarly, a “drain” of a transistor means a drain region that is part of the semiconductor film or a drain electrode connected to the semiconductor film. A “gate” means a gate electrode.

Note that in this specification and the like, a state in which transistors are connected in series means, for example, a state in which only one of a source and a drain of a first transistor is connected to only one of a source and a drain of a second transistor. In addition, a state in which transistors are connected in parallel means a state in which one of a source and a drain of a first transistor is connected to one of a source and a drain of a second transistor and the other of the source and the drain of the first transistor is connected to the other of the source and the drain of the second transistor.

Note that “connection” in this specification and the like means electrical connection and corresponds to the state in which current, voltage, or potential can be supplied, applied, or conducted. Therefore, a state of electrical connection means not only a state of direct connection but also a state of indirect connection through a circuit element such as a wiring, a resistor, a diode, or a transistor, in which current, voltage, or a potential can be supplied or transmitted.

In this specification and the like, even when different components are connected to each other in a circuit diagram, there is actually a case where one conductive film has functions of a plurality of components such as a case where part of a wiring serves as an electrode. The term “connection” in this specification and the like also means such a case where one conductive film has functions of a plurality of components.

Furthermore, in this specification and the like, one of a first electrode and a second electrode of a transistor refers to a source electrode and the other refers to a drain electrode.

For example, in this specification and the like, an explicit description “X and Y are connected” means that X and Y are electrically connected, X and Y are functionally connected, and X and Y are directly connected. Accordingly, without being limited to a predetermined connection relationship, for example, a connection relationship shown in drawings or texts, another connection relationship is included in the drawings or the texts.

Here, each of X and Y is an object (e.g., a device, an element, a circuit, a wiring, an electrode, a terminal, a conductive film, or a layer).

Examples of the case where X and Y are directly connected include the case where an element that allows an electrical connection between X and Y (e.g., a switch, a transistor, a capacitor, an inductor, a resistor, a diode, a display element, a light-emitting element, and a load) is not connected between X and Y, and the case where X and Y are connected without the element that allows the electrical connection between X and Y provided therebetween.

For example, in the case where X and Y are electrically connected, one or more elements that enable electrical connection between X and Y (e.g., a switch, a transistor, a capacitor, an inductor, a resistor, a diode, a display element, a light-emitting element, or a load) can be connected between X and Y. Note that the switch is controlled to be turned on or off. That is, the switch is conducting or not conducting (is turned on or off) to determine whether current flows therethrough or not. Alternatively, the switch has a function of selecting and changing a current path. Note that the case where X and Y are electrically connected includes the case where X and Y are directly connected.

For example, in the case where X and Y are functionally connected, one or more circuits that enable functional connection between X and Y (e.g., a logic circuit such as an inverter, a NAND circuit, or a NOR circuit; a signal converter circuit such as a DA converter circuit, an AD converter circuit, or a gamma correction circuit; a potential level converter circuit such as a power supply circuit (e.g., a step-up dc-dc converter, or a step-down dc-dc converter) or a level shifter circuit for changing the potential level of a signal; a voltage source; a current source; a switching circuit; an amplifier circuit such as a circuit that can increase signal amplitude, the amount of current, or the like, an operational amplifier, a differential amplifier circuit, a source follower circuit, or a buffer circuit; a signal generation circuit; a memory circuit; and/or a control circuit) can be connected between X and Y. Note that for example, in the case where a signal output from X is transmitted to Y even when another circuit is interposed between X and Y, X and Y are functionally connected. Note that the case where X and Y are functionally connected includes the case where X and Y are directly connected and the case where X and Y are electrically connected.

Note that in this specification and the like, an explicit description “X and Y are electrically connected” means that X and Y are electrically connected (i.e., the case where X and Y are connected with another element or another circuit provided therebetween), X and Y are functionally connected (i.e., the case where X and Y are functionally connected with another circuit provided therebetween), and X and Y are directly connected (i.e., the case where X and Y are connected without another element or another circuit provided therebetween). That is, in this specification and the like, the explicit description “X and Y are electrically connected” is the same as the description “X and Y are connected”.

Note that, for example, the case where a source (or a first terminal or the like) of a transistor is electrically connected to X through (or not through) Z1 and a drain (or a second terminal or the like) of the transistor is electrically connected to Y through (or not through) Z2, or the case where a source (or a first terminal or the like) of a transistor is directly connected to one part of Z1 and another part of Z1 is directly connected to X while a drain (or a second terminal or the like) of the transistor is directly connected to one part of Z2 and another part of Z2 is directly connected to Y, can be expressed by using any of the following expressions.

The expressions include, for example, “X, Y, a source (or a first terminal or the like) of a transistor, and a drain (or a second terminal or the like) of the transistor are electrically connected to each other, and X, the source (or the first terminal or the like) of the transistor, the drain (or the second terminal or the like) of the transistor, and Y are electrically connected to each other in this order”, “a source (or a first terminal or the like) of a transistor is electrically connected to X, a drain (or a second terminal or the like) of the transistor is electrically connected to Y, and X, the source (or the first terminal or the like) of the transistor, the drain (or the second terminal or the like) of the transistor, and Y are electrically connected to each other in this order”, and “X is electrically connected to Y through a source (or a first terminal or the like) and a drain (or a second terminal or the like) of a transistor, and X, the source (or the first terminal or the like) of the transistor, the drain (or the second terminal or the like) of the transistor, and Y are provided to be connected in this order”. When the connection order in a circuit configuration is defined by an expression similar to the above examples, a source (or a first terminal or the like) and a drain (or a second terminal or the like) of a transistor can be distinguished from each other to specify the technical scope.

Other examples of the expressions include, “a source (or a first terminal or the like) of a transistor is electrically connected to X through at least a first connection path, the first connection path does not include a second connection path, the second connection path is a path between the source (or the first terminal or the like) of the transistor and a drain (or a second terminal or the like) of the transistor, Z1 is on the first connection path, the drain (or the second terminal or the like) of the transistor is electrically connected to Y through at least a third connection path, the third connection path does not include the second connection path, and Z2 is on the third connection path”, and “a source (or a first terminal or the like) of a transistor is electrically connected to X at least with a first connection path through Z1, the first connection path does not include a second connection path, the second connection path includes a connection path through which the transistor is provided, a drain (or a second terminal or the like) of the transistor is electrically connected to Y at least with a third connection path through Z2, and the third connection path does not include the second connection path.” Still another example of the expression is “a source (or a first terminal or the like) of a transistor is electrically connected to X through at least Z1 on a first electrical path, the first electrical path does not include a second electrical path, the second electrical path is an electrical path from the source (or the first terminal or the like) of the transistor to a drain (or a second terminal or the like) of the transistor, the drain (or the second terminal or the like) of the transistor is electrically connected to Y through at least Z2 on a third electrical path, the third electrical path does not include a fourth electrical path, and the fourth electrical path is an electrical path from the drain (or the second terminal or the like) of the transistor to the source (or the first terminal or the like) of the transistor”. When the connection path in a circuit structure is defined by an expression similar to the above examples, a source (or a first terminal or the like) and a drain (or a second terminal or the like) of a transistor can be distinguished from each other to specify the technical scope.

Note that one embodiment of the present invention is not limited to these expressions that are just examples. Here, X, Y, Z1, and Z2 each denote an object (e.g., a device, an element, a circuit, a wiring, an electrode, a terminal, a conductive film, and a layer).

Even when independent components are electrically connected to each other in a circuit diagram, one component has functions of a plurality of components in some cases. For example, when part of a wiring also functions as an electrode, one conductive film functions as the wiring and the electrode. Thus, “electrical connection” in this specification includes in its category such a case where one conductive film has functions of a plurality of components.

### Embodiment 1

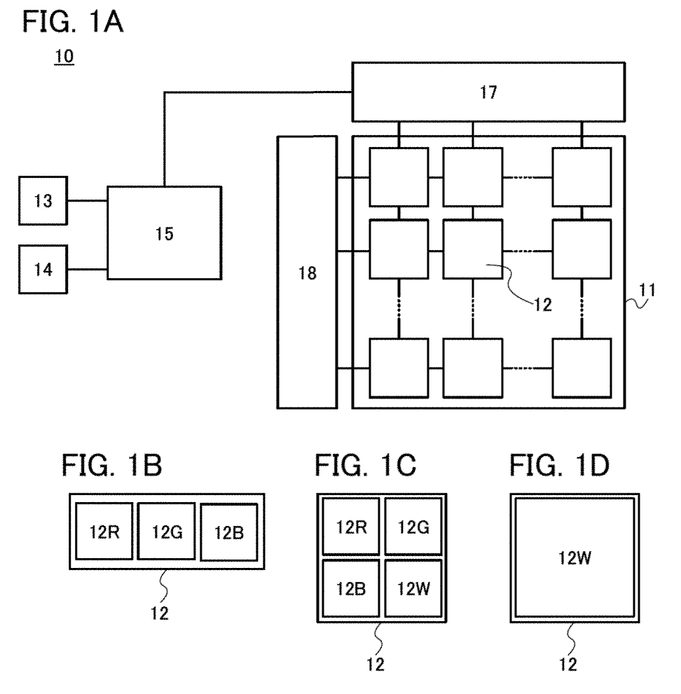

In this embodiment, a structure example of a display device and a display method of one embodiment of the present invention will be described with reference to FIGS. 1A to 1D, FIG. 2, FIGS. 3A to 3C, FIG. 4, FIG. 5, FIG. 6, FIGS. 7A and 7B, and FIG. 8.

One embodiment of the present invention relates to a display method and a display device that have a function of changing the luminance of a displayed image such that the luminance of a part that is watched by a user is different from the luminance of a part that is not watched by the user. Accordingly, for example, a high-contrast image can be displayed only on the part watched by the user and a low-luminance image can be displayed on the other part. Furthermore, for example, a high-contrast image can be displayed only on the part watched by the user and a part in the neighborhood of the part, and a low-luminance image can be displayed on the other part. Thus, the power consumption of the display device of one embodiment of the present invention can be reduced without a reduction in the display quality of an image that is recognized by the user.

The display device of one embodiment of the present invention may have a function of displaying text. The display device can also have a function of changing the luminance of displayed text such that the luminance of a part that is watched by a user is different from the luminance of a part that is not watched by the user. In the case where text is displayed on the display device, for example, only a row or a column of text watched by the user can be displayed at high contrast, and the other rows or columns can be displayed at low luminance. For example, only a row or a column of text watched by the user and a row or a column in the neighborhood of the row or the column can be displayed at high contrast, and the other rows or columns can be displayed at low luminance. Thus, the power consumption of the display device of one embodiment of the present invention can be reduced without a reduction in the display quality of text that is recognized by the user.

In this specification and the like, the term “image” includes text in some cases.

### [Structure Example 1 of Display Device]

FIG. 1A is a block diagram illustrating a structure example of a display device 10. The display device 10 includes a display portion 11, a sensor 13, a memory circuit 14, an arithmetic circuit 15, a source driver circuit 17, and a gate driver circuit 18. The display portion 11 includes a plurality of pixels 12 arranged in matrix. Note that the display portion 11 has a function of displaying an image using the pixels 12.

The pixels 12 each include a first display element. As the first display element, a light-emitting element having a function of emitting light can be used, for example. As the first display element, for example, a self-luminous light-emitting element such as an organic light-emitting diode (OLED), a light-emitting diode (LED), a quantum-dot light-emitting diode (QLED), an inorganic electroluminescence (IEL) element, or a semiconductor laser can be used, for example. The luminance and the chromaticity of light emitted from a display element including such a light-emitting element is not affected by external light. Therefore, an image with high color reproducibility (a wide color gamut) and a high contrast can be displayed on the display portion 11. That is, a high-quality image can be displayed on the display portion 11.

The pixels 12 can have subpixels. For example, as illustrated in FIG. 1B, the pixel 12 can have three types of subpixels: a subpixel 12R, a subpixel 12G, and a subpixel 12B. For example, a display element having a function of displaying white color can be provided in each of the subpixel 12R, the subpixel 12G, and the subpixel 12B; and a coloring layer that transmits red light (with wavelengths greater than or equal to 620 nm and less than or equal to 750 nm), a coloring layer that transmits green light (with wavelengths greater than or equal to 500 nm and less than 570 nm), and a coloring layer that transmits blue light (with wavelengths greater than or equal to 450 nm and less than 500 nm) can be provided in the subpixel 12R, the subpixel 12G, and the subpixel 12B, respectively. Accordingly, for example, the subpixel 12R has a function of emitting red light, the subpixel 12G has a function of emitting green light, and the subpixel 12B has a function of emitting blue light. Note that a subpixel having a function of emitting violet light (with wavelengths greater than or equal to 380 nm and less than 450 nm), yellow light (with wavelengths greater than or equal to 570 nm and less than 590 nm), orange light (with wavelengths greater than or equal to 590 nm and less than 620 nm), or the like may be provided instead of any of the subpixel 12R, the subpixel 12G, and the subpixel 12B or may be provided in addition to them.

The luminance of light emitted from the subpixels included in the pixels 12 can be represented with specific gray levels depending on digital data generated by the arithmetic circuit 15 described later. For example, in the case where the luminance of light emitted from the subpixels included in the pixels 12 is represented with 8-bit digital data per subpixel, the luminance of light emitted from the subpixels included in the pixels 12 can be represented with 256 gray levels. In this case, for example, the lowest luminance and the highest luminance can be represented by luminance 0 and luminance 255, respectively.

Note that for example, even in the case where the luminance of light emitted from the subpixels included in the pixels 12 can be represented with 256 gray levels, it is possible to represent the luminance with lower gray levels, e.g., 64 gray levels. In this case, for example, the lowest luminance and the highest luminance can be luminance 0 and luminance 63, respectively. That is, the subpixels included in the pixels 12 can be prevented from emitting light with luminance from luminance 64 to luminance 255. In this manner, by lowering the gray levels for representation of luminance of light emitted from the subpixels included in the pixels 12, the luminance of light emitted from the subpixels included in the pixels 12 can be lowered. Accordingly, an image can be displayed with low power consumption.

In this specification and the like, gray levels for representation of luminance of light emitted from subpixels are referred to as gray levels of the subpixels in some cases.

In this specification and the like, a gray level that can be represented with digital data generated from the arithmetic circuit 15 is referred to as a maximum gray level in some cases. For example, in the case where the luminance of light emitted from the subpixels included in the pixels 12 is represented with 8-bit digital data per subpixel, the maximum gray level can be 256. For example, in the case where the luminance of light emitted from the subpixels included in the pixels 12 is represented with m-bit (m is a natural number) digital data, the maximum gray level can be 2^{m}. That is, the maximum gray level refers to a gray level before lowering of the gray level.

In this specification and the like, an image that is displayed without lowering the gray level, i.e., an image that is displayed at a maximum gray level, is referred to as a high-contrast image in some cases. Furthermore, an image that is displayed after the gray level is lowered is referred to as a low-luminance image in some cases.

In this specification and the like, even in the case where an image is displayed at a lower gray level than the maximum gray level, the image is referred to as a high-contrast image in some cases when the gray level at the time of displaying the image is higher than a gray level at the time of displaying a low-luminance image. For example, in the case where the maximum gray level is 256 and the gray level at the time of displaying a low-luminance image is 64, an image that is displayed at a gray level of 100 can be referred to as a high-contrast image.

In the case of lowering the gray levels of the subpixels included in the pixels 12, the luminance of light emitted from the subpixels included in the pixels 12 can be adjusted by multiplying digital data generated from the arithmetic circuit 15 by a predetermined value, for example. For example, in the case where the maximum gray level is 256 and the luminance of light emitted from the subpixels included in the pixels 12 is represented with a gray level of 64, the luminance of light emitted from the subpixels included in the pixels 12 can be adjusted by multiplying digital data generated from the arithmetic circuit 15 by 0.25. In this case, for example, the subpixels that emit light with luminance 200 before the gray levels are lowered can emit light with luminance 50 after the gray levels are lowered. For example, in the case where the maximum gray level is M (M is an integer greater than or equal to 2) and the luminance of light emitted from the subpixels included in the pixels 12 is represented with a gray level of N (N is an integer greater than or equal to 2), the luminance of light emitted from the subpixels included in the pixels 12 can be adjusted by multiplying digital data generated from the arithmetic circuit 15 by N/M.

In the display device 10, gray levels for representation of the luminance of emitted light can be lowered in the subpixels included in all of the pixels 12, for example. That is, a low-luminance image can be displayed in the entire display portion 11. Such a display mode is referred to as an entire-screen low-luminance display mode in this specification and the like in some cases.

In the display device 10, the gray levels of the subpixels included in some of the pixels 12 can each be kept at a maximum gray level and the gray levels of the subpixels included in the other pixels 12 can be lowered, for example. The gray levels of the subpixels included in some of the pixels 12 can be made higher than the gray levels of the subpixels included in the other pixels 12. That is, a high-contrast image can be displayed only on part of the display portion 11, and a low-luminance image can be displayed on the other part. Such a display mode is referred to as a partial high contrast display mode in this specification and the like in some cases.

In the display device 10, the gray levels of the subpixels included in all of the pixels 12 can each be kept at a maximum gray level, for example. That is, a high-contrast image can be displayed on the entire display portion 11. The display portion 11 need not necessarily display an image.

In any of the display modes for displaying an image, the gray levels of the subpixels included in one pixel 12 are preferably the same.

As illustrated in FIG. 1C, the pixel 12 may have a subpixel 12W in addition to the subpixel 12R, the subpixel 12G, and the subpixel 12B. The subpixel 12W may have a structure which includes a display element having a function of displaying white color and does not include a coloring layer. Owing to the structure, the subpixel 12W has a function of emitting white light. This can increase the brightness of an image that is displayed on the display portion 11.

Note that the display elements included in the subpixel 12R, the subpixel 12G, and the subpixel 12B need not necessarily have a function of displaying white color. For example, a display element having a function of displaying red color, a display element having a function of displaying green color, and a display element having a function of displaying blue color may be provided in the subpixel 12R, the subpixel 12G, and the subpixel 12B, respectively. In this case, the pixel 12 can have a structure where a coloring layer is not provided.

Note that some of the pixels 12 may each have a structure where the subpixel 12R, the subpixel 12G, and the subpixel 12B are not provided and the subpixel 12W is provided as shown in FIG. 1D. That is, some of the pixels 12 may have a function of emitting only white light. This can increase the brightness of an image that is displayed on the display portion 11.

The sensor 13 has a function of taking an image of the surroundings of the display device 10 by detecting visible light, for example. Note that for example, the sensor 13 has a function of detecting infrared rays and a function of taking an infrared image of the surroundings of the display device 10. The sensor 13 may have a function of measuring the brightness of external light. The sensor 13 can include a photoelectric conversion element, for example.

The memory circuit 14 has a function of holding a program including information on the display method of the display device 10, for example. As the memory circuit 14, a non-temporary memory medium can be used. For example, a non-volatile memory such as a read only memory (ROM) can be used. As the ROM, a mask ROM, a one-time programmable read only memory (OTPROM), or an erasable programmable read only memory (EPROM) can be used. Examples of the EPROM include an ultra-violet erasable programmable read only memory (UV-EPROM) which can erase stored data by irradiation with ultraviolet rays, an electrically erasable programmable read only memory (EEPROM), and a flash memory.

As the memory circuit 14, a memory including a transistor where a metal oxide is used in a channel formation region may be used, for example. A metal oxide has a wider band gap and lower carrier density than silicon. Therefore, a transistor where a metal oxide is used in a channel formation region has lower off-state current than a transistor where silicon is used in a channel formation region. Thus, data can be held in the memory circuit 14 even when the supply of power to the memory circuit 14 is stopped, and thus, the memory circuit 14 has a function of a non-temporary memory medium.

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, a metal oxide used in a semiconductor layer of a transistor is called an oxide semiconductor in some cases. That is, in the case where a metal oxide has at least one of amplifying, rectifying, and switching effects, the metal oxide can be referred to as a metal oxide semiconductor (OS, for short). In addition, an OS FET is a transistor including a metal oxide or an oxide semiconductor.

In this specification and the like, a metal oxide including nitrogen is also called a metal oxide in some cases. Moreover, a metal oxide including nitrogen may be called a metal oxynitride.

In this specification and the like, “c-axis aligned crystal (CAAC)” or “cloud-aligned composite (CAC)” may be stated. CAAC refers to an example of a crystal structure, and CAC refers to an example of a function or a material composition.

In this specification and the like, a CAC-OS or a CAC metal oxide has a conducting function in a part of the material and has an insulating function in another part of the material; as a whole, the CAC-OS or the CAC metal oxide has a function of a semiconductor. In the case where the CAC-OS or the CAC metal oxide is used in a semiconductor layer of a transistor, the conducting function is to allow electrons (or holes) serving as carriers to flow, and the insulating function is to not allow electrons serving as carriers to flow. By the complementary action of the conducting function and the insulating function, the CAC-OS or the CAC metal oxide can have a switching function (on/off function). In the CAC-OS or CAC metal oxide, separation of the functions can maximize each function.

In this specification and the like, the CAC-OS or the CAC metal oxide includes conductive regions and insulating regions. The conductive regions have the above-described conducting function, and the insulating regions have the above-described insulating function. In some cases, the conductive regions and the insulating regions in the material are separated at the nanoparticle level. In some cases, the conductive regions and the insulating regions are unevenly distributed in the material. The conductive regions are observed to be coupled in a cloud-like manner with their boundaries blurred, in some cases.

Furthermore, in the CAC-OS or the CAC metal oxide, the conductive regions and the insulating regions each have a size of more than or equal to 0.5 nm and less than or equal to 10 nm, preferably more than or equal to 0.5 nm and less than or equal to 3 nm and are dispersed in the material, in some cases.

The CAC-OS or the CAC metal oxide includes components having different bandgaps. For example, the CAC-OS or the CAC metal oxide includes a component having a wide gap due to the insulating region and a component having a narrow gap due to the conductive region. In the case of such a composition, carriers mainly flow in the component having a narrow gap. The component having a narrow gap complements the component having a wide gap, and carriers also flow in the component having a wide gap in conjunction with the component having a narrow gap.

Therefore, in the case where the above-described CAC-OS or the CAC metal oxide is used in a channel region of a transistor, high current drive capability in the on state of the transistor, that is, high on-state current and high field-effect mobility, can be obtained.

In other words, a CAC-OS or CAC metal oxide can be called a matrix composite or a metal matrix composite.

The arithmetic circuit 15 has a function of generating digital data having information on an image that is displayed on the display portion 11. The digital data has information on the luminance of light emitted from the subpixels included in the pixels 12, for example. As described above, in the case where the luminance of light emitted from the subpixels included in the pixels 12 is represented with 8-bit digital data per subpixel, for example, the luminance of light emitted from the subpixels included in the pixel 12 can be represented with 256 gray levels.

The arithmetic circuit 15 has a function of reading a program having information on the display method of the display device 10 that is held in the memory circuit 14 and operating the display device 10 on the basis of the program. For example, the arithmetic circuit 15 has a function of analyzing an image of the surroundings that is taken by the sensor 13. For example, the arithmetic circuit 15 has a function of determining, using the image of the surroundings that is taken by the sensor 13, a part of the display portion 11 that is watched by a user of the display device 10 and determining, on the basis of the determined part, the luminance of an image that is displayed on each part of the display portion 11.

As the arithmetic circuit 15, a central processing unit (CPU), a digital signal processor (DSP), a graphics processing unit (GPU), or the like can be used. Furthermore, the arithmetic circuit 15 may be obtained with a programmable logic device (PLD) such as a field programmable gate array (FPGA) or a field programmable analog array (FPAA).

The source driver circuit 17 has a function of converting display data generated by the arithmetic circuit 15 from digital to analog and sending the display data subjected to the digital-to-analog conversion to the pixels 12. The gate driver circuit 18 has a function of supplying a selection signal to the pixels 12.

Note that part or all of the number of the memory circuits 14, the number of the arithmetic circuits 15, the number of the source driver circuits 17, and the number of the gate driver circuits 18 in the display device 10 may each be two or more.

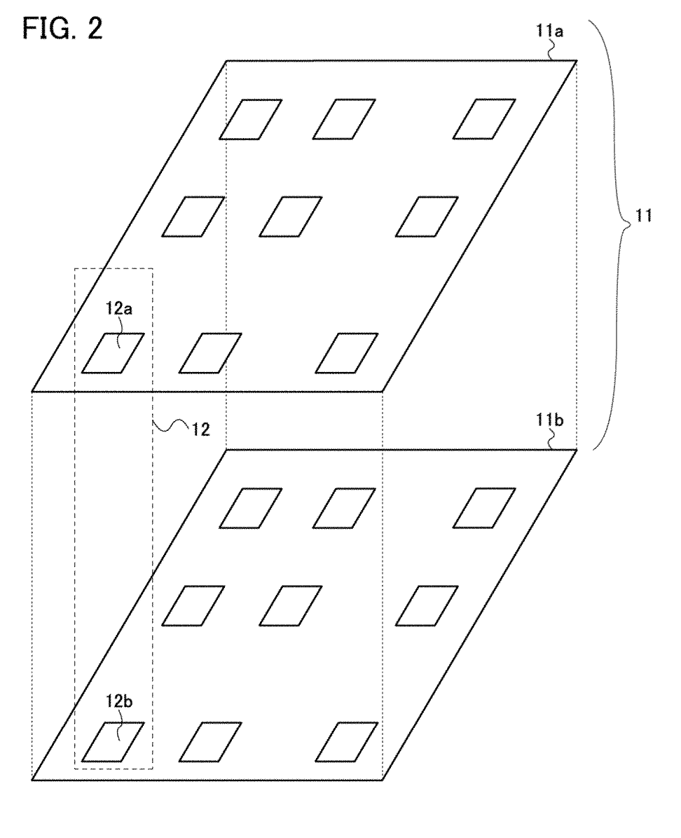

The pixel 12 may be provided with two or more pixels. For example, the pixel 12 may have a structure in which a pixel 12a and a pixel 12b are stacked as shown in FIG. 2. In the case where the pixel 12 has a structure shown in FIG. 2, the display portion 11 includes a display portion 11a and a display portion 11b. The pixel 12a is provided in the display portion 11a, and the pixel 12b is provided in the display portion 11b. That is, the display portion 11 has a structure in which the display portion 11a and the display portion 11b are stacked. Note that in FIG. 2, components other than the display portion 11 and the pixel 12 are not shown.

The pixels 12a each include a second display element. A non-light-emitting display element can be used as the second display element, for example. For example, a non-light-emitting display element having a function of displaying an image by reflecting external light can be used. As the non-light-emitting display element, a liquid crystal element can be used, for example. A reflective liquid crystal element can be used, for example. A transmissive liquid crystal element, a semi-transmissive liquid crystal element, or the like can be used. A reflective display element other than a liquid crystal element can be used, for example. The use of such an element as the second display element enables the display portion 11 to display an image using external light, which reduces the power consumption of the display device 10.

Note that the pixel 12a may include an electronic shutter, a mechanical shutter, or the like. The pixel 12a may include a piezoelectric element. The piezoelectric element includes a piezoelectric substance and has a function of converting voltage applied to the piezoelectric substance into power. The piezoelectric element has a function of operating a mechanical shutter, for example.

The pixels 12b each include the first display element. As described above, a light-emitting element can be used as the first display element, for example.

The pixel 12a and the pixel 12b can each include a subpixel as shown in FIGS. 1B, 1C, and 1D. Note that in one pixel 12, a subpixel included in the pixel 12a may be different from a subpixel included in the pixel 12b. For example, the pixel 12a and the pixel 12b may have the structure shown in FIG. 1D and the structure shown in FIG. 1B, respectively.

In the case where the pixels 12 each have, for example, the structure shown in FIG. 2, an image may be displayed using only the pixel 12a, only the pixel 12b, or both of the pixels 12a and 12b in each pixel 12. That is, of pixels included in the pixels 12, a pixel for use in displaying an image can be determined individually in each pixel 12.

Note that the proportion of the pixels 12 using the pixels 12a for displaying an image to all of the pixels 12 provided in the display portion 11 can be determined by the brightness of external light, for example. For example, in the case where external light is bright, the proportion of the pixels 12 using the pixels 12a for displaying an image is increased, so that the gray levels of the subpixels included in the pixels 12b can be lowered greatly. This enables the power consumption of the display device 10 to be reduced. The proportion of the pixels 12 using the pixels 12a for displaying an image may be set freely by a user of the display device 10, for example.

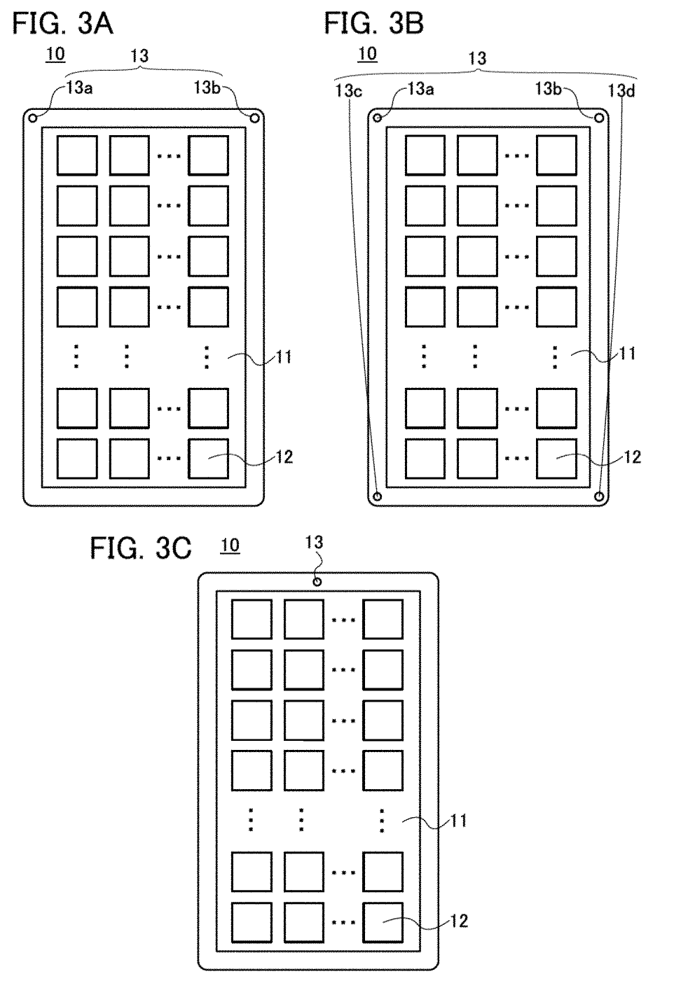

FIGS. 3A to 3C are schematic views of structure examples of the display device 10. In FIGS. 3A to 3C, components other than the display portion 11, the pixel 12, and the sensor 13 are not shown.

As shown in FIGS. 3A and 3B, two or more sensors 13 can be provided. With such a structure, the distance between a user of the display device 10 and the display portion 11 can be calculated, for example. Thus, a part of the display portion 11 that is watched by the user of the display device 10 can be calculated accurately, for example.

For example, as shown in FIG. 3A, the display device 10 may include two sensors, a sensor 13a and a sensor 13b, and the sensors may be provided in the upper left and the upper right of the display device 10. For example, as shown in FIG. 3B, the display device 10 may include four sensors, the sensor 13a, the sensor 13b, a sensor 13c, and a sensor 13d, and the sensors may be provided in the upper left, the upper right, the lower left, and the lower right of the display device 10. Note that the number of sensors of the sensor 13 may be three, or five or more.

As shown in FIG. 3C, the display device 10 may include only one sensor as the sensor 13. The sensor 13 can be provided in the upper part of the display device 10, for example. In the case where the display device 10 includes only one sensor, the power consumption of the display device 10 can be reduced.

Note that even in the case where the display device 10 includes only one sensor as the sensor 13, the distance between a user of the display device 10 and the display portion 11 can be calculated by calculating the distance between one of the eyes of the user of the display device 10 and the other eye of the user of the display device 10 in an image taken by the sensor 13, for example.

In the case where the sensor 13 can have the above-described function, the sensor can be provided in a desired position of the display device 10. The sensor 13 may include a fixed-focus or variable-focus optical device (e.g., lens) and an image sensor capable of detecting visible light and/or capable of two-dimensional detection.

### [Display Method Example 1]

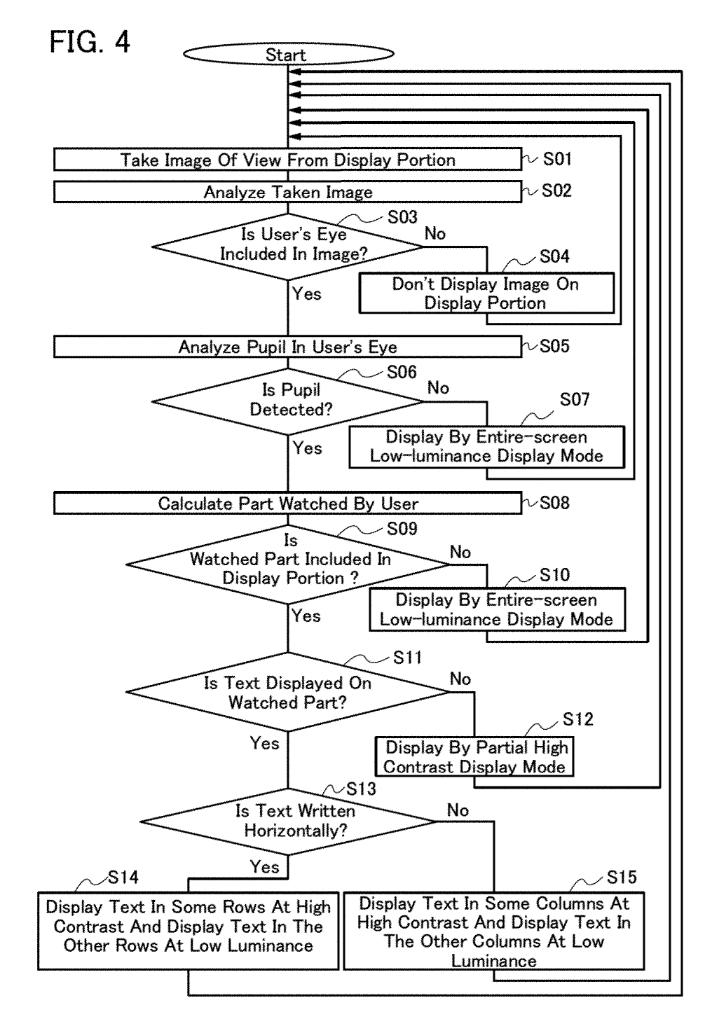

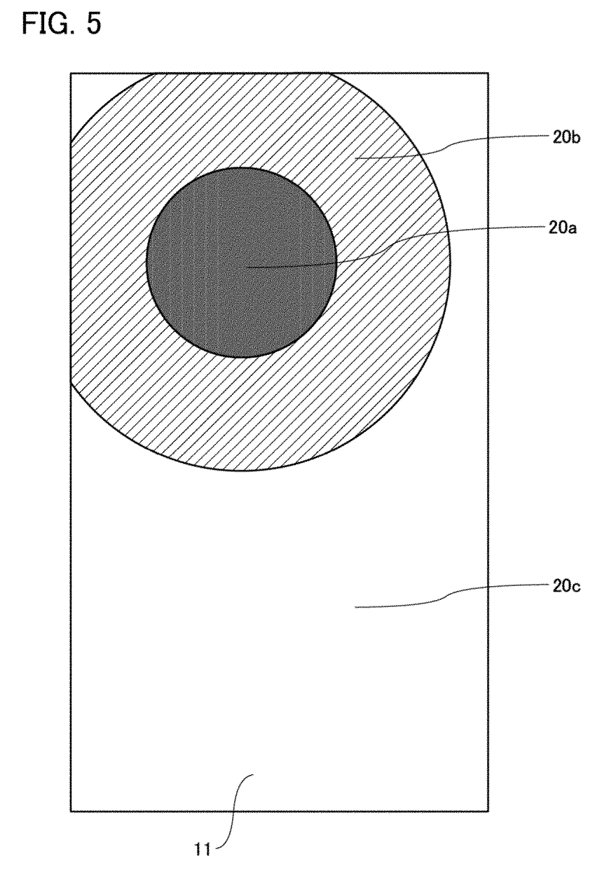

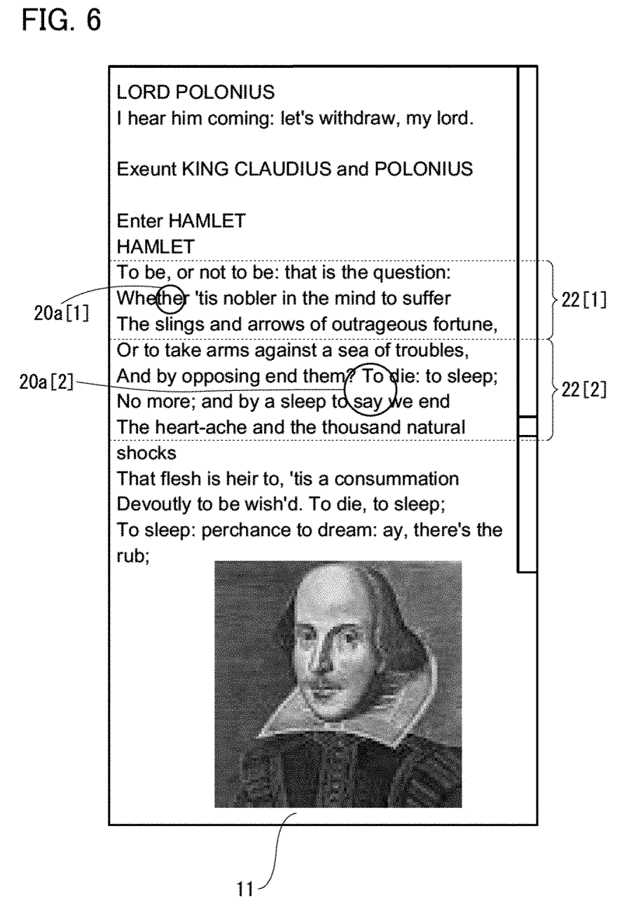

An example of a program for execution of a display method of the display device 10 having the structure shown in FIG. 1A is described with reference to FIG. 4, FIG. 5, and FIG. 6. Note that for example, in the case where two or more pixels are provided in the pixel 12 as shown in FIG. 2, the pixel 12 may also be referred to as a pixel including a light-emitting element (in FIG. 2, the pixel 12b) in the description of the display method.

FIG. 4 is a flow chart illustrating the example of the program for execution of the display method of the display device 10 having the structure shown in FIG. 1A. First, an image of the view from the display portion 11 of the display device 10 is taken by the sensor 13 (Step S01). Next, the image taken by the sensor 13 is analyzed by the arithmetic circuit 15 (Step S02). For example, it is determined whether or not an eye of a user of the display device 10 is included in the image taken by the sensor 13 (Step S03). In the case where an eye of the user of the display device 10 is not included in the image, it can be assumed that the display portion 11 is not in the visual field of the user of the display device 10. Thus, it is not necessary to display an image on the display portion 11, for example (Step S04). This enables the power consumption of the display device 10 to be reduced.

In the case where an eye of the user of the display device 10 is included in the image, it can be assumed that the display portion 11 is in the visual field of the user of the display device 10. In this case, the pupil in the eye is analyzed by the arithmetic circuit 15 (Step 505). For example, it is determined whether or not the pupil in the eye of the user of the display device 10 is detected from the image taken by the sensor 13 (Step S06). In the case where the pupil is not detected, it can be assumed that the user of the display device 10 is far away from the display portion 11. In this case, a significant problem will not occur even when the contrast of an image displayed on the display portion 11 is not high; an image can be displayed by the entire-screen low-luminance display mode, for example (Step S07). This enables the power consumption of the display device 10 to be reduced. The display portion 11 need not necessarily display an image in Step S07. In this case, the power consumption of the display device 10 can be further reduced.

In the case where the pupil is detected, a part watched by the user of the display device 10 is calculated by analyzing the direction and the position of the pupil, the distance to the display portion 11, and the like with the arithmetic circuit 15 (Step S08). The distance from the pupil to the display portion 11 can be calculated from the distance between the pupil of one of the eyes of the user of the display device 10 and the pupil of the other eye of the user of the display device 10 in the image taken by the sensor 13. Note that in the case where the sensor 13 includes two or more sensors, even when only the pupil in one of the eyes of the user of the display device 10 is detected, the distance from the pupil to the display portion 11 can be calculated.

Next, it is determined whether or not the part watched by the user of the display device 10 is included in the display portion 11 (Step S09). In the case where the part is not included in the display portion 11, it can be assumed that the attention of the user of the display device 10 is diverted from the display portion 11 though the display portion 11 is in the visual field of the user of the display device 10. In this case, a significant problem will not occur even when the contrast of an image displayed on the display portion 11 is not high; an image can be displayed by the entire-screen low-luminance display mode, for example (Step S10). This enables the power consumption of the display device 10 to be reduced.

In the case where the part watched by the user of the display device 10 is included in the display portion 11, it is determined whether or not text is displayed on the part watched by the user (Step S11). In the case where text is not displayed, an image can be displayed by the partial high contrast display mode (Step S12). For example, a high-contrast image is displayed only on the part watched by the user of the display device 10 and a part in the neighborhood of the part, and a low-luminance image is displayed on the other part. For example, a high-contrast image is displayed only on the part watched by the user of the display device 10, and a low-luminance image is displayed on the other part.

In this specification and the like, the term “text” refers to a group of letters displayed on the display portion 11.

Step S12 is described in detail with reference to FIG. 5. FIG. 5 shows the display portion 11 in which a part 20a watched by the user of the display device 10, a part 20b in the neighborhood of the part 20a, and a part 20c other than the part 20a and the part 20b are illustrated.

The part 20a can be calculated in Step S08 as described above. A specific area outside the part 20a can be defined as the part 20b. For example, in the case where the part 20a has a circle shape, the part 20b can have a circle shape whose center is the same as that of the part 20a and whose radius is obtained by adding a numerical value x (x is greater than or equal to 0) to a radius of the part 20a. The numerical value x may be fixed, set freely by the user of the display device 10, or set automatically depending on given conditions such as the brightness of external light.

Note that the shape of the part 20a is not limited to a circle and can be an ellipse, a rectangle, a triangle, a quadrangle, a polygon, or other shapes. The shape of the part 20b can be set depending on the shape of the part 20a.

In the case where an image is displayed by the partial high contrast display mode, for example, a high-contrast image can be displayed on the part 20a and the part 20b, and a low-luminance image can be displayed on the part 20c, for example. That is, the gray levels of the subpixels included in the pixels 12 in the part 20a and the part 20b can each be set to the maximum gray level, and the gray levels of the subpixels included in the pixels 12 in the part 20c can be made lower than the maximum gray level. The gray levels of the subpixels included in the pixels 12 in the part 20a and the part 20b can be made higher than the gray levels of the subpixels included in the pixels 12 in the part 20c.

In the case where an image is displayed by the partial high contrast display mode, for example, a high-contrast image can be displayed on the part 20a, and a low-luminance image can be displayed on the part 20b and the part 20c. That is, the gray levels of the subpixels included in the pixels 12 in the part 20a can each be set to the maximum gray level, and the gray levels of the subpixels included in the pixels 12 in the part 20b and the part 20c can be made lower than the maximum gray level. The gray levels of the subpixels included in the pixels 12 in the part 20a can be made higher than the gray levels of the subpixels included in the pixels 12 in the part 20b and the part 20c.

In the case where an image is displayed by the partial high contrast display mode, the gray levels of the subpixels included in the pixels 12 in the part 20b can be made lower than or equal to the gray levels of the subpixels included in the pixels 12 in the part 20a and higher than or equal to the gray levels of the subpixels included in the pixels 12 in the part 20c. For example, in the case where the gray levels of the subpixels included in the pixels 12 in the part 20a are each set to 256 and the gray levels of the subpixels included in the pixels 12 in the part 20c are each set to 64, the gray levels of the subpixels included in the pixels 12 in the part 20b can be set to be higher than or equal to 64 and lower than or equal to 256. That is, for example, the gray levels of the subpixels included in the pixels 12 in the part 20b can each be set to be higher than or equal to the gray level at the time of displaying a low-luminance image and lower than or equal to the maximum gray level. Thus, the luminance of an image displayed on the part 20b can be higher than or equal to the luminance of an image displayed on the part 20c and lower than or equal to the luminance of an image displayed on the part 20a.

For example, in the pixels 12 included in the part 20b, the gray levels of the subpixels included in the pixels 12 provided in the part close to the part 20a can be set to be high, and the gray levels of the subpixels included in the pixels 12 provided in the part close to the part 20c (the part far from the part 20a) can be set to be low. This can prevent a significant change in contrast at the boundary between the part 20a and the part 20b and the boundary between the part 20b and the part 20c.

Also in the pixels 12 included in the part 20a, the gray levels of the subpixels included in some of the pixels 12 may be set to be lower than the maximum gray level and lower than the gray levels of the subpixels included in the pixels 12 in the part 20c. Also in the pixels 12 included in the part 20c, the gray levels of the subpixels included in some of the pixels 12 may be set to be higher than the gray levels of the subpixels included in the pixels 12 in the part 20a and set to be the maximum gray level.

In the case where text is displayed on the part watched by the user of the display device 10 in Step S11, it is determined whether the text is written horizontally or vertically (Step S13). In the case where the text is written horizontally, some of rows can be displayed at high contrast and the other rows can be displayed at low luminance, for example (Step S14). In the case where the text is written vertically, some of columns can be displayed at high contrast and the other columns can be displayed at low luminance, for example (Step S15). For example, a row or a column of text included in a part watched by the user of the display device 10 and a row or a column in the neighborhood of the row or the column can be displayed at high contrast, and the other rows or columns can be displayed at low luminance.

In Step S14 and Step S15, the luminance of text and the luminance of the background of the text on each of the parts of the display portion 11 can be set freely by the user of the display device 10, for example. Furthermore, letters of text in one row (in the case where the text is written horizontally) or one column (in the case where the text is written vertically) may vary in the luminance of a letter and the luminance of the background of a letter.

In this specification and the like, “displaying a row at high contrast” means that displaying is performed with the gray level of text in the row and the gray level of the background of the row set to a maximum gray level. For example, when the maximum gray level is set to 256 (the lowest luminance is set to luminance 0 and the highest luminance is set to luminance 255), maximum values of the luminance of light emitted from the subpixels included in the pixels 12 in the row can each be set to luminance 255.

In this specification and the like, “displaying a row at low luminance” means that displaying is performed with the gray level of text in the row and the gray level of the background of the row set to be lower than a maximum gray level.

In this specification and the like, “displaying a column at high contrast” means that displaying is performed with the gray level of text in the column and the gray level of the background of the column set to a maximum gray level. In this specification and the like, “displaying a column at low luminance” means that displaying is performed with the gray level of text in the column and the gray level of the background of the column set to be lower than a maximum gray level.

In this specification and the like, displaying a row or a column at a gray level higher than a gray level of a row or a column that is displayed at low luminance is also referred to as “displaying a column or a row at high contrast” in some cases even when the row or the column is not displayed at a maximum gray level.

Step S14 is described in detail with reference to FIG. 6. FIG. 6 shows the display portion 11 on which text is written horizontally.

The part 20a is a region watched by a user of the display device 10 as described using FIG. 5. A row of text included in the part 20a can be displayed at high contrast and the other rows can be displayed at low luminance, for example.

In this specification and the like, particularly when components with the same reference symbol need to be distinguished from each other, signs such as [1] and [2] are used. For example, a plurality of parts 20a and the like are distinguishably shown as a part 20a[1], a part 20a[2], and the like. Note that the user of the display device 10 does not watch all of the plurality of parts 20a and can watch one part 20a, for example.

For example, it is assumed that the part 20a[1] shown in FIG. 6 is watched by the user of the display device 10. In the part 20a[1], part of “Whether” is included. Therefore, a row “Whether ‘tis nobler in the mind to suffer” can be displayed at high contrast and the other rows can be displayed at low luminance. That is, for example, the gray levels of the subpixels included in the pixels 12 in the row “Whether ‘tis nobler in the mind to suffer” can each be set to a maximum gray level, and the gray levels of the subpixels included in the pixels 12 in the other rows can each be made lower than the maximum gray level. For example, the gray levels of the subpixels included in the pixels 12 in the row “Whether ‘tis nobler in the mind to suffer” can each be set to be higher than the gray levels of the subpixels included in the pixels 12 in the other rows.

A row of text included in the part 20a and a row in the neighborhood of the row can be displayed at high contrast, and the other rows can be displayed at low luminance, for example. For example, a row previous to the row of text included in the part 20a and a row next to the row of text included in the part 20a can be defined as rows in the neighborhood of the row. For example, in the case where the part 20a[1] is watched by the user of the display device 10, a row “To be, or not to be: that is the question:” and a row “The slings and arrows of outrageous fortune,” can be defined as rows in the neighborhood of the row “Whether ‘tis nobler in the mind to suffer” including the part 20a[1]. In this case, a row of text included in the part 20a[1] and rows in the neighborhood of the row (three rows in total) are collectively shown by a row 22[1].

The row 22[1] can be displayed at high contrast, and the other rows can be displayed at low luminance, for example. That is, for example, the gray levels of the subpixels included in the pixels 12 in the row 22[1] can each be set to a maximum gray level, and the gray levels of the subpixels included in the pixels 12 in the other rows can each be made lower than the maximum gray level. For example, the gray levels of the subpixels included in the pixels 12 in the row 22[1] can be made higher than the gray levels of the subpixels included in the pixels 12 in the other rows.

Note that two rows previous to the row of text included in the part 20a and two rows next to the row of text included in the part 20a may be defined as rows in the neighborhood of the row, or three or more rows previous to the row and three or more rows next to the row may be defined as rows in the neighborhood of the row.

Text included in the part 20a is not necessarily in one row. For example, text in two rows may be included as in the part 20a[2]. Alternatively, text in three or more rows may be included in the part 20a.

It is assumed that the part 20a[2] shown in FIG. 6 is watched by the user of the display device 10, for example. In this case, for example, a row “And by opposing end them? To die: to Sleep;” and a row “No more; and by a sleep to say we end” can be displayed at high contrast, and the other rows can be displayed at low luminance. That is, for example, the gray levels of the subpixels included in the pixels 12 in the row “And by opposing end them? To die: to Sleep;” and the row “No more; and by a sleep to say we end” can each be set to a maximum gray level, and the gray levels of the subpixels included in the pixels 12 in the other rows can each be set to be lower than the maximum gray level. For example, the gray levels of the subpixels included in the pixels 12 in the row “And by opposing end them? To die: to Sleep;” and the row “No more; and by a sleep to say we end” can be set to be higher than the gray levels of the subpixels included in the pixels 12 in the other rows.

A row “Or to take arms against a sea of troubles,” that is one row above “And by opposing end them? To die: to Sleep;” and a row “The heart-ache and the thousand natural” that is one row below “No more; and by a sleep to say we end” can be defined as rows in the neighborhood of the row of text included in the part 20a, for example. A row of text included in the part 20a[2] and rows in the neighborhood of the row (four rows in total) in this case is collectively shown by a row 22[2].

The row 22[2] can be displayed at high contrast, and the other rows can be displayed at low luminance, for example. That is, for example, the gray levels of the subpixels included in the pixels 12 in the row 22[2] can each be set to a maximum gray level, and the gray levels of the subpixels included in the pixels 12 in the other rows can each be set to be lower than the maximum gray level. For example, the gray levels of the subpixels included in the pixels 12 in the row 22[2] can be set to be higher than the gray levels of the subpixels included in the pixels 12 in the other rows.

Also in the case where text in three or more rows is included in the part 20a, whether the text is displayed at high contrast or low luminance can be determined in each row as in the case where text in one row or two rows is included in the part 20a.

Note that part of a row that is not a row of text included in the part 20a and not a row in the neighborhood of the row may be displayed at high contrast.

In the case where the display device 10 is operated in a manner described in Step S15, i.e., in the case where text is vertically written in a part watched by the user of the display device 10, the description of Step S14 can be referred to after “row” is replaced with “column” in the description of Step S14.

Note that the determination shown in Step S03, Step S06, Step S09, Step S11, and Step S13 can be performed by artificial intelligence (AI), for example.

In Step 505, the distance between an eye of the user of the display device 10 and the display portion 11 can be calculated instead of analyzing the pupil in the eye of the user of the display device 10. The distance between the eye of the user of the display device 10 and the display portion 11 can be calculated from the distance between one of the eyes of the user of the display device 10 and the other eye of the user of the display device 10 in an image taken by the sensor 13, for example. Note that in the case where the sensor 13 includes two or more sensors, even when only one of the eyes of the user of the display device 10 is detected, the distance from the pupil to the display portion 11 can be calculated.

In the above-described case, for example, whether or not the distance between the eye of the user of the display device 10 and the display portion 11 is longer than or equal to a predetermined distance is determined in Step S06. In the case where the distance is longer than or equal to the predetermined distance, the process proceeds to Step S07 and an image can be displayed only on the display portion 11a, for example. In the case where the distance is shorter than the predetermined distance, the process proceeds to Step S08 and the part watched by the user of the display device 10 can be calculated from the position of the eye of the user of the display device 10, the distance to the display portion 11, and the like.

As described above, in the display method of one embodiment of the present invention, a high-contrast image can be displayed on the part watched by the user of the display device 10 and a low-luminance image can be displayed on the other part. In the display method of one embodiment of the present invention, a high-contrast image can be displayed on the part watched by the user of the display device 10 and the part in the neighborhood of the part and a low-luminance image can be displayed on the other part. Thus, the power consumption of the display device 10 can be reduced without a reduction in the quality of an image that is recognized by the user of the display device 10. In particular, in the case where the display portion 11 has a high resolution, the power consumption of the display device 10 can be reduced greatly.

In the display method of one embodiment of the present invention, in the case where text is displayed on the part watched by the user of the display device 10, a row or a column of text watched by the user can be displayed at high contrast, and the other rows or columns can be displayed at low luminance. In the display method of one embodiment of the present invention, a row or a column of text watched by the user and a row or a column in the neighborhood of the row or the column can be displayed at high contrast, the other rows or columns can be displayed at low luminance. As described above, the power consumption of the display device 10 can be reduced without a reduction in the display quality of text that is recognized by the user of the display device 10.

### [Structure Example 2 of Display Device]

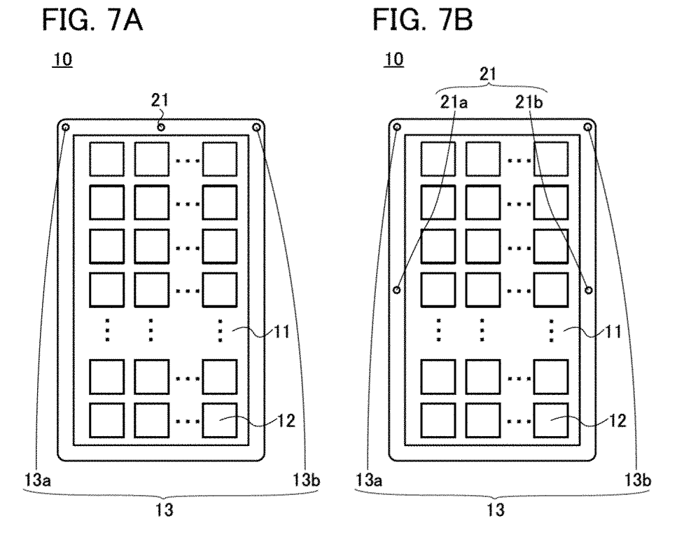

The display device 10 may be operated using infrared light. FIGS. 7A and 7B show examples of a schematic view of the display device 10 in the case where the display device 10 shown in FIG. 3A is provided with an infrared source 21.

One infrared source 21 can be provided for the display device 10, for example. For example, as shown in FIG. 7A, the infrared source 21 can be provided in the upper part of the display device 10. Two or more infrared sources can be provided as the infrared source 21, for example. For example, as shown in FIG. 7B, an infrared source 21a and an infrared source 21b can be provided in the left part of the display device 10 and the right part of the display device 10, respectively. Note that the infrared source 21 may include three or more infrared sources. In the display device 10, an infrared source can be provided at any position as long as the infrared source 21 can have a function described below.

The infrared source 21 has a function of emitting light such as infrared light. The infrared source 21 has a function of emitting near infrared light, for example. The infrared source 21 has a function of emitting light with a wavelength higher than or equal to 0.9 μm and lower than or equal to 1.6 μm, for example. As the infrared source 21, a semiconductor laser can be used, for example. The infrared source 21 that uses a laser can emit light with an extremely narrow spectrum width.

In the case where the infrared source 21 is provided in the display device 10, light emitted from the infrared source 21 can be detected by the sensor 13, for example. For example, light emitted from the infrared source 21 is reflected by a user of the display device 10 or the like, and the reflected light can be detected by the sensor 13. For example, a sensor intended for the detection of infrared light or the like is provided in the display device 10, and light emitted from the infrared source 21 can be detected by the sensor. Note that a filter for selectively transmitting light with a wavelength that is emitted from the infrared source 21 may be provided for the part or the whole of a sensor having a function of detecting light emitted from the infrared source 21. This enables a reduction of noise due to infrared light or the like in the external environment.

### [Display Method Example 2]

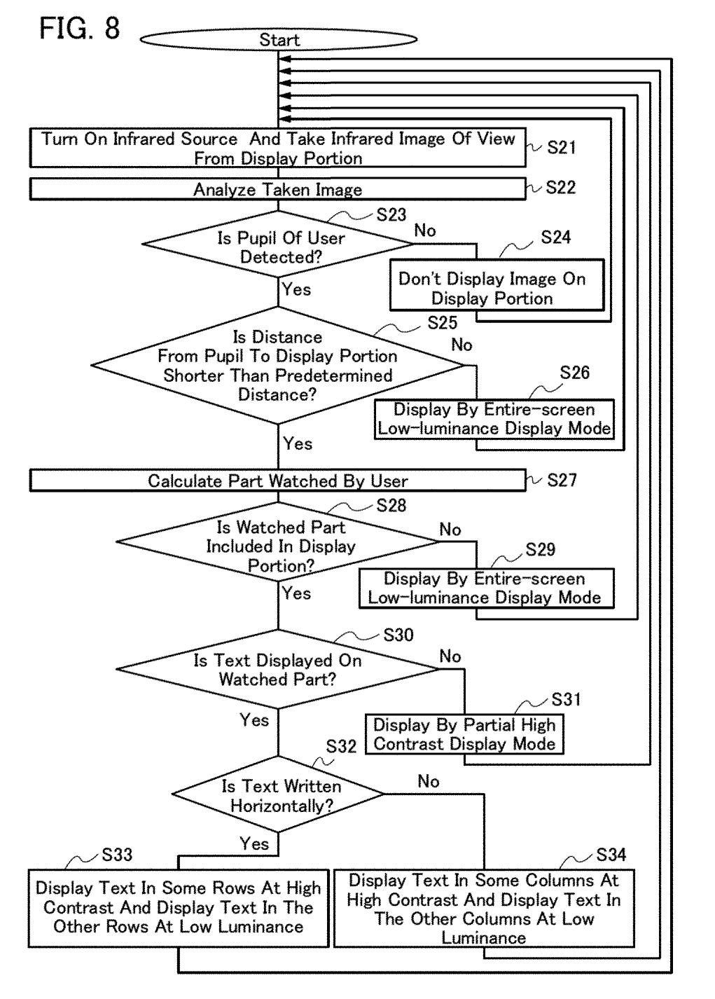

Next, an example of a program for execution of the display method of the display device 10 provided with the infrared source 21 as shown in FIGS. 7A and 7B is described with reference to FIG. 8. Note that for example, in the case where two or more pixels are provided in the pixel 12 as shown in FIG. 2, the pixel 12 may also be referred to as a pixel including a light-emitting element (in FIG. 2, the pixel 12b) in the description of this display method.

FIG. 8 is a flow chart illustrating the example of the program for execution of the display method of the display device 10 provided with the infrared source 21.

First, the infrared source 21 is turned on, and an infrared image of the view from the display portion 11 of the display device 10 is taken by the sensor 13 (Step S21). Next, the infrared image taken by the sensor 13 is analyzed by the arithmetic circuit 15 (Step S22). For example, it is determined whether or not the pupil of an eye of a user of the display device 10 is included in the infrared image taken by the sensor 13 (Step S23).

The pupil of a human eye has extremely high reflectivity of light with wavelengths from red to near infrared. Therefore, the pupil of an eye of a user of the display device 10 can be detected accurately without detection of the eye. Moreover, the pupil of an eye of a user of the display device 10 can be detected speedily without detection of the eye; thus, the display device 10 can be operated at higher speed.

In the case where the pupil of the eye of the user of the display device 10 is not included in the infrared image taken by the sensor 13, it can be assumed that the display portion 11 is not in the visual field of the user of the display device 10. Thus, it is not necessary to display an image on the display portion 11 (Step S24). This enables the power consumption of the display device 10 to be reduced.

In the case where the pupil of the eye of the user of the display device 10 is included in the image, it can be assumed that the display portion 11 is in the visual field of the user of the display device 10. In this case, the distance from the pupil to the display portion 11 is calculated by the arithmetic circuit 15 (Step S25). In the case where the distance is longer than or equal to a predetermined distance, an image can be displayed by the entire-screen low-luminance display mode, for example (Step S26). This enables the power consumption of the display device 10 to be reduced. The display portion 11 need not necessarily display an image in Step S26. In this case, the power consumption of the display device 10 can be further reduced.

Note that as described above, the distance from the pupil to the display portion 11 can be calculated from the distance between the pupil of one of the eyes of the user of the display device 10 and the pupil of the other eye of the user of the display device 10 in the image taken by the sensor 13, for example. Note that in the case where the sensor 13 includes two or more sensors, even when only the pupil in one of the eyes of the user of the display device 10 is detected, the distance from the pupil to the display portion 11 can be calculated.

In the case where the distance from the pupil to the display portion 11 is shorter than the predetermined distance, a part watched by the user of the display device 10 is calculated from the direction and the position of the pupil, the distance to the display portion 11, and the like (Step S27).

Steps S28 to S34 performed after Step S27 can be similar to Steps S09 to S15 shown in FIG. 4.

By the above-described display method shown in FIG. 8, the pupil of an eye of a user of the display device 10 can be accurately detected using infrared light without detection of the eye.

Note that the determination shown in Step S23, Step S25, Step S28, Step S30, and Step S32 can be performed by AI, for example.

A step can be added to the steps shown in FIG. 4 and FIG. 8, a step in the steps shown in FIG. 4 and FIG. 8 can be skipped, and the order of the steps shown in FIG. 4 and FIG. 8 can be changed as appropriate in the range in which the function of the display device 10 is not lost.

At least part of this embodiment can be implemented in combination with any of the other embodiments described in this specification as appropriate.

### Embodiment 2

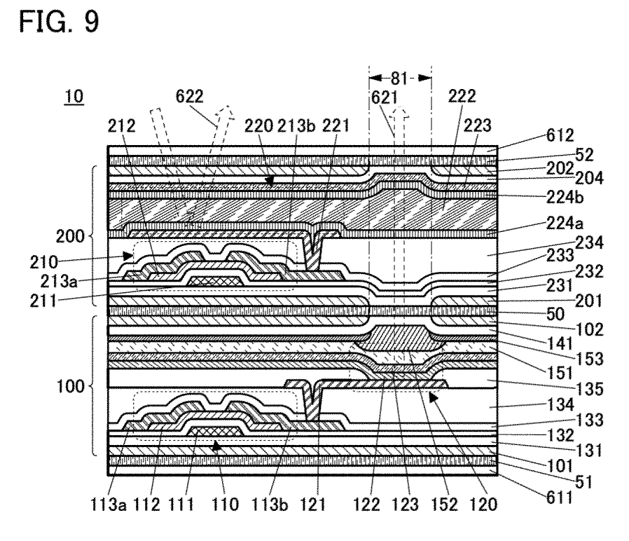

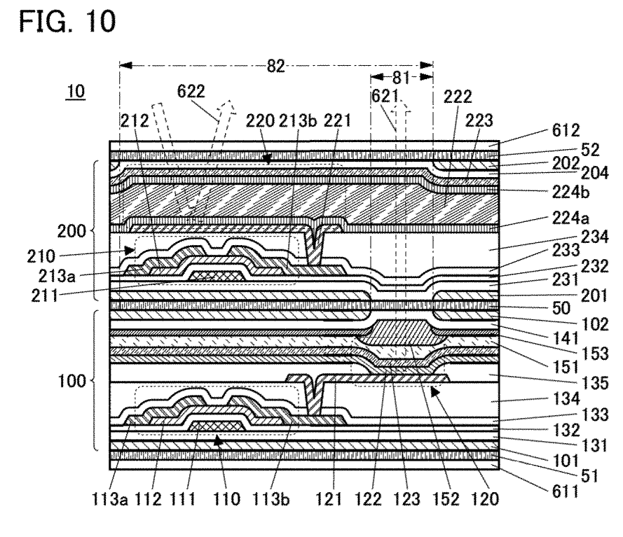

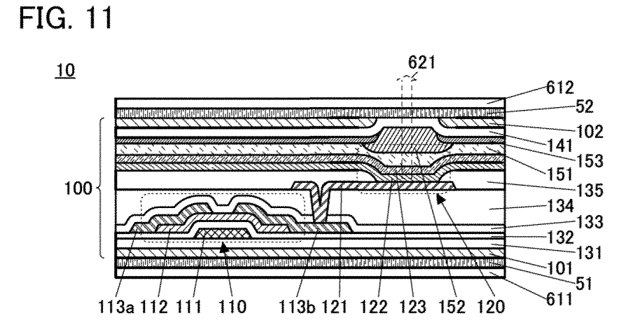

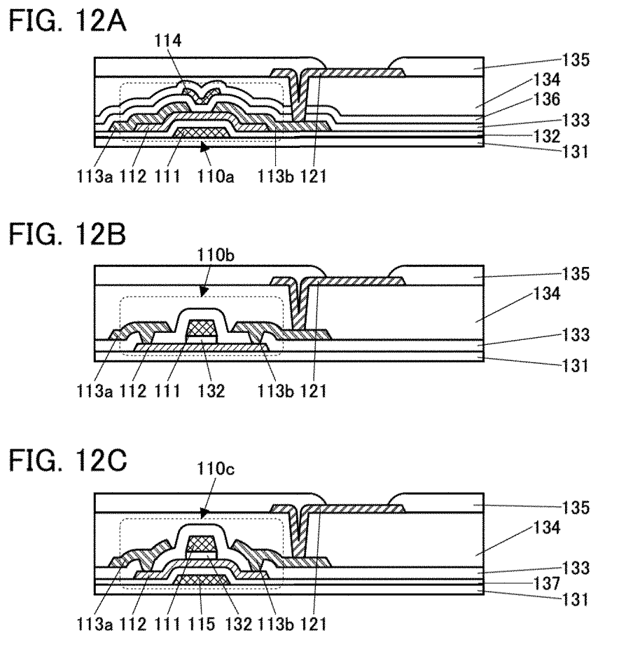

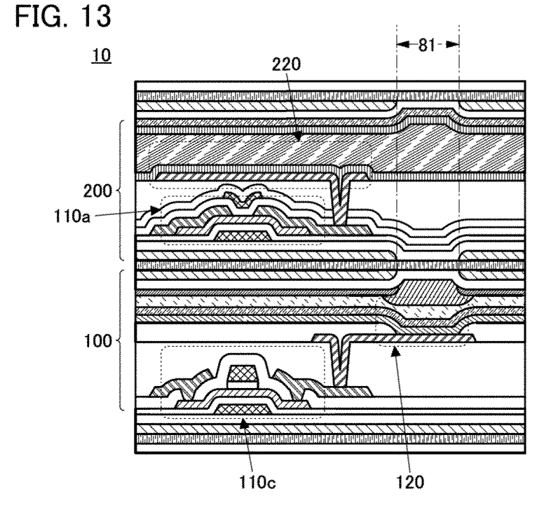

In this embodiment, a display device of one embodiment of the present invention and a manufacturing method thereof will be described with reference to FIG. 9, FIG. 10, FIG. 11, FIGS. 12A to 12C, and FIG. 13.

A display device of one embodiment of the present invention has a structure where a first display panel and a second display panel are bonded to each other with an adhesive layer therebetween. In the first display panel, the pixels 12a that include non-light-emitting display elements are provided. In the second display panel, the pixels 12b that include light-emitting elements are provided. As the non-light-emitting display element, a non-light-emitting display element having a function of displaying an image by reflecting external light can be used, for example. For example, a liquid crystal element can be used. For example, a reflective liquid crystal element, a transmissive liquid crystal element, or a semi-transmissive liquid crystal element can be used. In particular, in the case where a reflective liquid crystal element is used, gray levels can be produced by control of the amount of reflected light. Note that light-emitting elements can produce gray levels by controlling the amount of light emission.

The display device can perform display by using only reflected light, display by using only light emitted from the light-emitting elements, and display by using both reflected light and light emitted from the light-emitting elements, for example.

The first display panel is provided on the viewing side. The second display panel is provided on the side opposite to the viewing side. The first display panel includes a first resin layer in a position closest to the adhesive layer. The second display panel includes a second resin layer in a position closest to the adhesive layer.

It is preferable that a third resin layer be provided on the display surface side of the first display panel and a fourth resin layer be provided on the rear surface side (the side opposite to the display surface side) of the second display panel. Thus, the display device can be extremely lightweight and less likely to be broken.

The first to fourth resin layers (hereinafter also collectively referred to as a resin layer) have a feature of being extremely thin. Specifically, it is preferable that each of the resin layers have a thickness greater than or equal to 0.1 μm and less than or equal to 3 μm. Thus, even a structure in which the two display panels are stacked can have a small thickness. Furthermore, light absorption due to the resin layer positioned in the path of light emitted from the light-emitting element in the pixel 12b can be reduced, so that light can be extracted with higher efficiency and the power consumption can be reduced.

The resin layer can be formed in the following manner, for example. A thermosetting resin material with a low viscosity is applied on a support substrate and cured by heat treatment to form the resin layer. Then, a structure is formed over the resin layer. Then, the resin layer and the support substrate are separated from each other, whereby one surface of the resin layer is exposed.

As a method of reducing adhesion between the support substrate and the resin layer to separate the support substrate and the resin layer from each other, laser light irradiation is given. For example, it is preferable to perform the irradiation by scanning using linear laser light. By the method, the process time of the case of using a large support substrate can be shortened. As the laser light, excimer laser light with a wavelength of 308 nm can be suitably used.

A thermosetting polyimide is a typical example of a material that can be used for the resin layer. It is particularly preferable to use a photosensitive polyimide. A photosensitive polyimide is a material that is suitably used for formation of a planarization film or the like of the display panel, and therefore, the formation apparatus and the material can be shared. Thus, there is no need to prepare another apparatus and another material to obtain the structure of one embodiment of the present invention.

Furthermore, the resin layer that is formed using a photosensitive resin material can be processed by light exposure and development treatment. For example, an opening can be formed and an unnecessary portion can be removed. Moreover, by optimizing a light exposure method or light exposure conditions, an uneven shape can be formed in a surface of the resin layer. For example, an exposure technique using a half-tone mask or a gray-tone mask or a multiple exposure technique may be used.

Note that a non-photosensitive resin material may be used. In that case, a method of forming an opening or an uneven shape using a resist mask or a hard mask that is formed over the resin layer can be used.

In this case, part of the resin layer that is positioned in the path of light emitted from the light-emitting element is preferably removed. That is, an opening overlapping with the light-emitting element is provided in the first resin layer and the second resin layer. Thus, a reduction in color reproducibility and light extraction efficiency that is caused by absorption of part of light emitted from the light-emitting element by the resin layer can be inhibited.

Alternatively, the resin layer may be provided with a concave portion so that a portion of the resin layer that is positioned in the path of light emitted from the light-emitting element is thinner than the other portion. That is, the resin layer may have a structure in which two portions with different thicknesses are included and the portion with a smaller thickness overlaps with the light-emitting element. The resin layer that has the structure can also reduce absorption of light emitted from the light-emitting element.

In the case where the first display panel includes the third resin layer, an opening overlapping with the light-emitting element is preferably provided in a manner similar to that described above. Thus, color reproducibility and light extraction efficiency can be further increased.

In the case where the first display panel includes the third resin layer, part of the third resin layer that is positioned in the path of light of the liquid crystal element is preferably removed. That is, an opening overlapping with the liquid crystal element is provided in the third resin layer. Thus, in the case where a reflective liquid crystal element is used as the liquid crystal element, for example, the reflectivity can be increased. In the case where a transmissive liquid crystal element is used as the liquid crystal element, for example, the transmissivity can be increased.

In the case where the opening is formed in the resin layer, a light absorption layer is formed over the support substrate, the resin layer having the opening is formed over the light absorption layer, and a light-transmitting layer covering the opening is formed. The light absorption layer is a layer that emits a gas such as hydrogen or oxygen by absorbing light and being heated. By performing light irradiation from the support substrate side to make the light absorption layer emit a gas, adhesion at the interface between the light absorption layer and the support substrate or between the light absorption layer and the light-transmitting layer can be reduced to cause separation, or the light absorption layer itself can be broken to cause separation.

As another example, the following method can be used. That is, a thin part is formed in a portion where the opening of the resin layer is to be formed, and the support substrate and the resin layer are separated from each other by the above-described method. Then, plasma treatment or the like is performed on a separated surface of the resin layer to reduce the thickness of the resin layer, whereby the opening can be formed in the thin part of the resin layer.

Each of the pixel 12a and the pixel 12b preferably includes a transistor. Furthermore, a metal oxide is preferably used as a semiconductor where a channel of the transistor is formed. A metal oxide can achieve high on-state current and high reliability even when the highest temperature in the manufacturing process of the transistor is reduced (e.g., lower than or equal to 400° C., preferably lower than or equal to 350° C.). Furthermore, in the case of using a metal oxide, high heat resistance is not required for a material of the resin layer positioned on the surface side on which the transistor is formed; thus, the material of the resin layer can be selected from a wider range of alternatives. For example, the material can be the same as a resin material of the planarization film.

In the case of using low-temperature polysilicon (LTPS), for example, processes such as a laser crystallization process, a baking process before crystallization, and a baking process for activating impurities are required, and the highest temperature in the manufacturing process of the transistor is higher than that in the case of using a metal oxide (e.g., higher than or equal to 500° C., higher than or equal to 550° C., or higher than or equal to 600° C.), though high field-effect mobility can be obtained. Therefore, high heat resistance is required for the resin layer positioned on the surface side on which the transistor is formed. In addition, the thickness of the resin layer needs to be comparatively large (e.g., greater than or equal to 10 μm, or greater than or equal to 20 μm) because the resin layer is also irradiated with laser light in the laser crystallization process.

In contrast, in the case of using a metal oxide, a special material having high heat resistance is not required for the resin layer, and the resin layer need not be formed thick. Thus, the proportion of the cost of the resin layer in the cost of the whole display panel can be reduced.

A metal oxide has a wide band gap (e.g., 2.5 eV or more, or 3.0 eV or more) and transmits light. Thus, even when a metal oxide is irradiated with laser light in a step of separating the support substrate and the resin layer, the laser light is hardly absorbed, so that the electrical characteristics can be less affected. Therefore, the resin layer can be thin as described above.

In one embodiment of the present invention, a display device excellent in productivity can be obtained by using both a resin layer that is formed thin using a photosensitive resin material with a low viscosity typified by a photosensitive polyimide and a metal oxide with which a transistor having excellent electrical characteristics can be obtained even at a low temperature.

Next, a pixel structure will be described. The pixels 12a and the pixels 12b are arranged in a matrix to form the display portion 11 as shown in FIG. 2 of Embodiment 1. In addition, the display device 10 preferably includes a first driver portion for driving the pixels 12a and a second driver portion for driving the pixels 12b. It is preferable that the first driver portion be provided in the first display panel and the second driver portion be provided in the second display panel.

The pixels 12a and the pixels 12b are preferably arranged in a display region with the same pitch as shown in FIG. 2 of Embodiment 1. Furthermore, the pixels 12a and the pixels 12b are preferably mixed in the display region of the display device. Accordingly, as described later, an image displayed by a plurality of pixels 12a, an image displayed by a plurality of pixels 12b, and an image displayed by both the plurality of pixels 12a and the plurality of pixels 12b can be displayed in the same display region.

Next, transistors that can be used in the first display panel and the second display panel will be described. A transistor provided in the pixel 12a of the first display panel and a transistor provided in the pixel 12b of the second display panel may have either the same structure or different structures.

As a structure of the transistor, a bottom-gate structure is given, for example. A transistor having a bottom-gate structure includes a gate electrode below a semiconductor layer (on the formation surface side). A source electrode and a drain electrode are provided in contact with a top surface and a side end portion of the semiconductor layer, for example.

As another structure of the transistor, a top-gate structure is given, for example. A transistor having a top-gate structure includes a gate electrode above a semiconductor layer (on the side opposite to the formation surface side). A first source electrode and a first drain electrode are provided over an insulating layer covering part of a top surface and a side end portion of the semiconductor layer and are electrically connected to the semiconductor layer through openings provided in the insulating layer, for example.

The transistor preferably includes a first gate electrode and a second gate electrode that face each other with the semiconductor layer provided therebetween.

A more specific example of the display device of one embodiment of the present invention will be described below with reference to drawings.

### [Structure Example 1]

FIG. 9 is a schematic cross-sectional view of the display device 10. In the display device 10, a display panel 100 and a display panel 200 are bonded to each other with an adhesive layer 50. The display device 10 includes a substrate 611 on the rear side (the side opposite to the viewing side) and a substrate 612 on the front side (the viewing side).

The display panel 100 includes a transistor 110 and a light-emitting element 120 between a resin layer 101 and a resin layer 102. The display panel 200 includes a transistor 210 and a liquid crystal element 220 between a resin layer 201 and a resin layer 202. The resin layer 101 is bonded to the substrate 611 with an adhesive layer 51 positioned therebetween. The resin layer 202 is bonded to the substrate 612 with an adhesive layer 52 positioned therebetween.

The resin layer 102, the resin layer 201, and the resin layer 202 are each provided with an opening. A region 81 illustrated in FIG. 9 is a region overlapping with the light-emitting element 120 and overlapping with the opening of the resin layer 102, the opening of the resin layer 201, and the opening of the resin layer 202.

### [Display Panel 100]

The resin layer 101 is provided with the transistor 110, the light-emitting element 120, an insulating layer 131, an insulating layer 132, an insulating layer 133, an insulating layer 134, an insulating layer 135, and the like. The resin layer 102 is provided with a light-blocking layer 153, a coloring layer 152, and the like. The resin layer 101 and the resin layer 102 are bonded to each other with an adhesive layer 151.

The transistor 110 is provided over the insulating layer 131 and includes a conductive layer 111 functioning as a gate electrode, part of the insulating layer 132 functioning as a gate insulating layer, a semiconductor layer 112, a conductive layer 113a functioning as one of a source electrode and a drain electrode, and a conductive layer 113b functioning as the other of the source electrode and the drain electrode.

The semiconductor layer 112 preferably includes a metal oxide.

The insulating layer 133 and the insulating layer 134 cover the transistor 110. The insulating layer 134 functions as a planarization layer.

The light-emitting element 120 includes a conductive layer 121, an EL layer 122, and a conductive layer 123 that are stacked. The conductive layer 121 has a function of reflecting visible light, and the conductive layer 123 has a function of transmitting visible light. Therefore, the light-emitting element 120 is a light-emitting element having a top-emission structure which emits light to the side opposite to the formation surface side.

The conductive layer 121 is electrically connected to the conductive layer 113b through an opening provided in the insulating layer 134 and the insulating layer 133. The insulating layer 135 covers an end portion of the conductive layer 121 and is provided with an opening to expose a top surface of the conductive layer 121. The EL layer 122 and the conductive layer 123 are provided in this order to cover the insulating layer 135 and the exposed portion of the conductive layer 121.

An insulating layer 141 is provided on the resin layer 101 side of the resin layer 102. The light-blocking layer 153 and the coloring layer 152 are provided on the resin layer 101 side of the insulating layer 141. The coloring layer 152 is provided in a region overlapping with the light-emitting element 120. The light-blocking layer 153 includes an opening in a portion overlapping with the light-emitting element 120.

The insulating layer 141 covers the opening of the resin layer 102. A portion of the insulating layer 141 that overlaps with the opening of the resin layer 102 is in contact with the adhesive layer 50.

### [Display Panel 200]

The resin layer 201 is provided with the transistor 210, a conductive layer 221, an alignment film 224a, an insulating layer 231, an insulating layer 232, an insulating layer 233, an insulating layer 234, and the like. The resin layer 202 is provided with an insulating layer 204, a conductive layer 223, an alignment film 224b, and the like. Liquid crystal 222 is interposed between the alignment film 224a and the alignment film 224b. The resin layer 201 and the resin layer 202 are bonded to each other with an adhesive layer in a region not illustrated.

The transistor 210 is provided over the insulating layer 231 and includes a conductive layer 211 functioning as a gate electrode, part of the insulating layer 232 functioning as a gate insulating layer, a semiconductor layer 212, a conductive layer 213a functioning as one of a source electrode and a drain electrode, and a conductive layer 213b functioning as the other of the source electrode and the drain electrode.

The semiconductor layer 212 preferably includes a metal oxide.

The insulating layer 233 and the insulating layer 234 cover the transistor 210. The insulating layer 234 functions as a planarization layer.

The liquid crystal element 220 includes the conductive layer 221, the conductive layer 223, and the liquid crystal 222 positioned therebetween. The conductive layer 221 has a function of reflecting visible light, and the conductive layer 223 has a function of transmitting visible light. Thus, a reflective liquid crystal element can be obtained as the liquid crystal element 220 shown in FIG. 9. Note that in the case where the conductive layer 221 has a function of transmitting visible light, a transmissive liquid crystal element can be obtained as the liquid crystal element 220.

The conductive layer 221 is electrically connected to the conductive layer 213b through an opening provided in the insulating layer 234 and the insulating layer 233. The alignment film 224a covers surfaces of the conductive layer 221 and the insulating layer 234.

The conductive layer 223 and the alignment film 224b are stacked on the resin layer 201 side of the resin layer 202. Note that the insulating layer 204 is provided between the resin layer 202 and the conductive layer 223. In addition, a coloring layer for coloring light reflected by the liquid crystal element 220 may be provided.

The insulating layer 231 covers the opening of the resin layer 201. A portion of the insulating layer 231 that overlaps with the opening of the resin layer 202 is in contact with the adhesive layer 50. The insulating layer 204 covers the opening of the resin layer 202. A portion of the insulating layer 204 that overlaps with the opening of the resin layer 202 is in contact with the adhesive layer 52.

### [Display Device 10]

The display device 10 includes a portion where the light-emitting element 120 does not overlap with the liquid crystal element 220 when being seen from above. Thus, light 621 that is colored by the coloring layer 152 is emitted from the light-emitting element 120 to the viewing side as illustrated in FIG. 9. Furthermore, reflected light 622 that is external light reflected by the conductive layer 221 is emitted through the liquid crystal 222 of the liquid crystal element 220.

The light 621 emitted from the light-emitting element 120 is emitted to the viewing side through the opening of the resin layer 102, the opening of the resin layer 201, and the opening of the resin layer 202. Since the resin layer 102, the resin layer 201, and the resin layer 202 are not provided in the path of the light 621, even in the case where the resin layer 102, the resin layer 201, and the resin layer 202 absorb part of visible light, high light extraction efficiency and high color reproducibility can be obtained.

Note that the substrate 612 functions as a polarizing plate or a circular polarizing plate. A polarizing plate or a circular polarizing plate may be located outward from the substrate 612.

In the above-described structure of the display panel 200, a coloring layer is not included and color display is not performed, but a coloring layer may be provided on the resin layer 202 side to perform color display.

The above is the description of the structure example.

### [Modification Example of Structure Example]

A structure example that is partly different from the structure example illustrated in FIG. 9 will be described below.

In FIG. 9, the opening is provided in a portion of the resin layer that is located in the path of light from the light-emitting element 120; however, an opening may be provided also in a portion of the resin layer that is located in the path of light of the liquid crystal element 220.

FIG. 10 illustrates an example in which a region 82 is included in addition to the region 81. The region 82 overlaps with the opening of the resin layer 202 and the liquid crystal element 220.

In the example illustrated in FIG. 10, the resin layer 202 is provided with one opening in which an opening overlapping with the light-emitting element 120 and an opening overlapping with the liquid crystal element 220 are included. Alternatively, the opening overlapping with the light-emitting element 120 and the opening overlapping with the liquid crystal element 220 may be separately provided.

Note that although the display panel 100 and the display panel 200 are included in the display device 10 in FIG. 9, the display panel 200 is not necessarily included as illustrated in FIG. 11. With the structure, a manufacturing process of the display device 10 can be simplified.

### [Transistor]

The display device 10 exemplified in FIG. 9 shows an example of using bottom-gate transistors as the transistor 110 and the transistor 210.

In the transistor 110, the conductive layer 111 functioning as a gate electrode is positioned closer to the formation surface (the resin layer 101 side) than the semiconductor layer 112. The insulating layer 132 covers the conductive layer 111. The semiconductor layer 112 covers the conductive layer 111. A region of the semiconductor layer 112 that overlaps with the conductive layer 111 corresponds to a channel formation region. The conductive layers 113a and 113b are provided in contact with the top surface and side end portions of the semiconductor layer 112.

Note that in the transistor 110 shown as an example, the width of the semiconductor layer 112 is wider than that of the conductive layer 111. In such a structure, the semiconductor layer 112 is positioned between the conductive layer 111 and each of the conductive layers 113a and 113b. Thus, the parasitic capacitance between the conductive layer 111 and each of the conductive layers 113a and 113b can be reduced.

The transistor 110 is a channel-etched transistor and can be suitably used for a high-resolution display device because the occupation area of the transistor can be reduced comparatively easily.

The transistor 210 and the transistor 110 have common characteristics.

A structure example of a transistor that can be used for the transistor 110 and the transistor 210 will be described.

A transistor 110a illustrated in FIG. 12A is different from the transistor 110 in that the transistor 110a includes a conductive layer 114 and an insulating layer 136. The conductive layer 114 is provided over the insulating layer 133 and includes a region overlapping with the semiconductor layer 112. The insulating layer 136 covers the conductive layer 114 and the insulating layer 133.

The conductive layer 114 is positioned to face the conductive layer 111 with the semiconductor layer 112 interposed therebetween. In the case where the conductive layer 111 is used as a first gate electrode, the conductive layer 114 can function as a second gate electrode. By supplying the same potential to the conductive layer 111 and the conductive layer 114, the on-state current of the transistor 110a can be increased. By supplying a potential for controlling the threshold voltage to one of the conductive layer 111 and the conductive layer 114 and a potential for driving to the other, the threshold voltage of the transistor 110a can be controlled.

A conductive material including an oxide is preferably used as the conductive layer 114. In that case, a conductive film to be the conductive layer 114 is formed in an atmosphere containing oxygen, whereby oxygen can be supplied to the insulating layer 133. The proportion of an oxygen gas in a film formation gas is preferably higher than or equal to 90% and lower than or equal to 100%. Oxygen supplied to the insulating layer 133 is supplied to the semiconductor layer 112 by heat treatment to be performed later, so that oxygen vacancies in the semiconductor layer 112 can be reduced.

It is particularly preferable to use, as the conductive layer 114, a metal oxide whose resistance is reduced. In this case, the insulating layer 136 is preferably formed using an insulating film that releases hydrogen, for example, a silicon nitride film. Hydrogen is supplied to the conductive layer 114 during the formation of the insulating layer 136 or by heat treatment to be performed after that, whereby the electrical resistance of the conductive layer 114 can be reduced effectively.

A transistor 110b illustrated in FIG. 12B is a top-gate transistor.

In the transistor 110b, the conductive layer 111 functioning as a gate electrode is provided over the semiconductor layer 112 (provided on the side opposite to the formation surface side). The semiconductor layer 112 is formed over the insulating layer 131. The insulating layer 132 and the conductive layer 111 are stacked over the semiconductor layer 112. The insulating layer 133 covers the top surface and the side end portions of the semiconductor layer 112, side surfaces of the insulating layer 132, and the conductive layer 111. The conductive layers 113a and 113b are provided over the insulating layer 133. The conductive layers 113a and 113b are electrically connected to the top surface of the semiconductor layer 112 through openings provided in the insulating layer 133.

Note that although the insulating layer 132 is not present in a portion that does not overlap with the conductive layer 111 in the example, the insulating layer 132 may be provided in a portion covering the top surface and the side end portion of the semiconductor layer 112.

In the transistor 110b, the physical distance between the conductive layer 111 and the conductive layer 113a or 113b can be easily increased, so that the parasitic capacitance therebetween can be reduced.

A transistor 110c illustrated in FIG. 12C is different from the transistor 110b in that the transistor 110c includes a conductive layer 115 and an insulating layer 137. The conductive layer 115 is provided over the insulating layer 131 and includes a region overlapping with the semiconductor layer 112. The insulating layer 137 covers the conductive layer 115 and the insulating layer 131.

The conductive layer 115 functions as a second gate electrode like the conductive layer 114. Thus, the on-state current can be increased and the threshold voltage can be controlled, for example.

In the display device 10, the transistor included in the display panel 100 and the transistor included in the display panel 200 may be different from each other. For example, the transistor 110a or the transistor 110c can be used as the transistor that is electrically connected to the light-emitting element 120 because a comparatively large amount of current needs to be fed to the transistor, and the transistor 110 can be used as the other transistor to reduce the occupation area of the transistor.

FIG. 13 illustrates an example of the case where the transistor 110a is used instead of the transistor 210 in FIG. 9 and the transistor 110c is used instead of the transistor 110 in FIG. 9.

The above is the description of the transistor.

At least part of this embodiment can be implemented in combination with any of the other embodiments described in this specification as appropriate.

### Embodiment 3

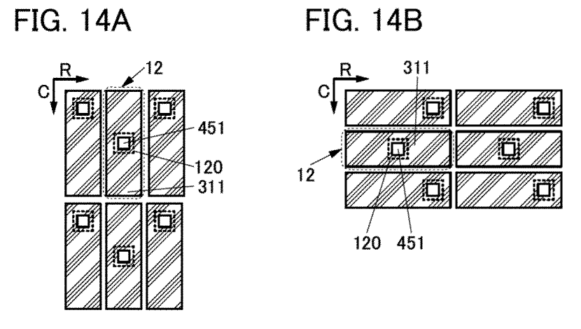

In this embodiment, specific examples of a display device of one embodiment of the present invention will be described with reference to FIGS. 14A and 14B, FIG. 15, FIGS. 16A and 16B, FIG. 17, FIG. 18, FIG. 19, FIG. 20, and FIG. 21. A display device including both a liquid crystal element and a light-emitting element will be described below.

In the case where the pixel 12 described in Embodiment 1 includes a liquid crystal element and a light-emitting element, the liquid crystal element and the light-emitting element overlap with each other in a portion.

FIG. 14A illustrates a structure example of an electrode 311 included in the pixel 12. The electrode 311 serves as a reflective electrode of the liquid crystal element in the pixel 12. The electrode 311 includes an opening 451.

In FIG. 14A, the light-emitting element 120 in a region overlapping with the electrode 311 is denoted by a dashed line. The light-emitting element 120 overlaps with the opening 451 included in the electrode 311. Thus, light from the light-emitting element 120 is emitted to a display surface side through the opening 451.

In FIG. 14A, the pixels 12 adjacent in the direction R correspond to different emission colors. As shown in FIG. 14A, the openings 451 are preferably provided in different positions in the electrodes 311 so as not to be aligned in the two pixels adjacent to each other in the direction R. This allows the two light-emitting elements 120 to be apart from each other, thereby preventing light emitted from the light-emitting element 120 from entering a coloring layer in the adjacent pixel 12 (such a phenomenon is also referred to as “crosstalk”). Furthermore, since the two adjacent light-emitting elements 120 can be arranged apart from each other, a high-resolution display device is achieved even when EL layers of the light-emitting elements 120 are separately formed with a shadow mask or the like.

Alternatively, arrangement shown in FIG. 14B may be employed.

If the ratio of the total area of the opening 451 to the total area except for the opening is too large, display performed using the liquid crystal element is dark. If the ratio of the total area of the opening 451 to the total area except for the opening is too small, display performed using the light-emitting element 120 is dark.

If the area of the opening 451 in the electrode 311 serving as a reflective electrode is too small, light emitted from the light-emitting element 120 is not efficiently extracted.

The shape of the opening 451 can be, for example, polygonal, quadrangular, elliptical, circular, or cross-shaped. Alternatively, the opening 451 may have a stripe shape, a slit shape, or a checkered pattern. The opening 451 may be close to the adjacent pixel. Preferably, the opening 451 is provided close to another pixel emitting light of the same color, in which case crosstalk can be suppressed.

### [Circuit Configuration Example]

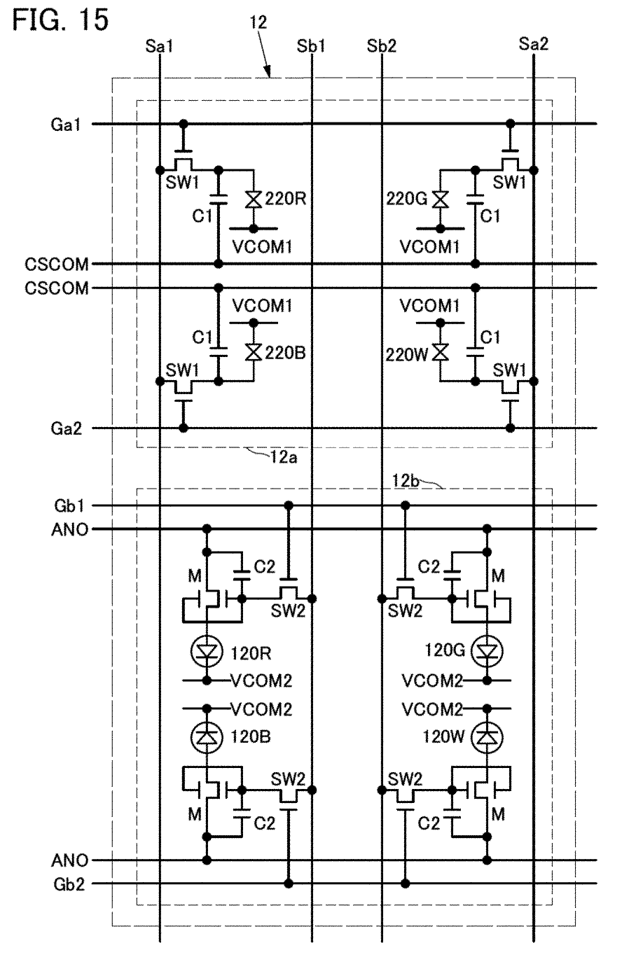

FIG. 15 is a circuit diagram illustrating a structure example of the pixel 12. The pixel 12 includes the pixel 12a that includes a liquid crystal element and the pixel 12b that includes a light-emitting element. The pixel 12a includes switches SW1, capacitors C1, liquid crystal elements 220 (a liquid crystal element 220R, a liquid crystal element 220G, a liquid crystal element 220B, and a liquid crystal element 220W), and the like. The pixel 12b includes switches SW2, transistors M, capacitors C2, light-emitting elements 120 (a light-emitting element 120R, a light-emitting element 120G, a light-emitting element 120B, and a light-emitting element 120W), and the like.

The pixel 12a is electrically connected to a wiring Ga1, a wiring Ga2, a wiring CSCOM, a wiring Sa1, and a wiring Sa2. The pixel 12b is electrically connected to a wiring Gb1, a wiring Gb2, a wiring ANO, a wiring Sb1, and a wiring Sb2.

In FIG. 15, a wiring VCOM1 that is electrically connected to the liquid crystal element 220R, the liquid crystal element 220G, the liquid crystal element 220B, and the liquid crystal element 220W is shown. In FIG. 15, a wiring VCOM2 that is electrically connected to the light-emitting element 120R, the light-emitting element 120G, the light-emitting element 120B, and the light-emitting element 120W is shown.

FIG. 15 illustrates an example in which a transistor is used as each of the switches SW1 and SW2.

A gate of the switch SW1 is connected to the wiring Ga1 or the wiring Ga2. One of a source and a drain of the switch SW1 is connected to the wiring Sa1 or the wiring Sa2. The other of the source and the drain of the switch SW1 is connected to one electrode of the capacitor C1 and one electrode of the liquid crystal element 220R, the liquid crystal element 220G, the liquid crystal element 220B, or the liquid crystal element 220W. The other electrode of the capacitor C1 is connected to the wiring CSCOM. The other electrode of the liquid crystal element 220R, the other electrode of the liquid crystal element 220G, the other electrode of the liquid crystal element 220B, and the other electrode of the liquid crystal element 220W are connected to the wiring VCOM1.

A gate of the switch SW2 is connected to the wiring Gb1 or the wiring Gb2. One of a source and a drain of the switch SW2 is connected to the wiring Sb1 or the wiring Sb2. The other of the source and the drain of the switch SW2 is connected to one electrode of the capacitor C2 and gates of the transistor M. The other electrode of the capacitor C2 is connected to one of a source and a drain of the transistor M and the wiring ANO. The other of the source and the drain of the transistor M is connected to one electrode of the light-emitting element 120R, the light-emitting element 120G, the light-emitting element 120B, or the light-emitting element 120W. The other electrode of the light-emitting element 120R, the other electrode of the light-emitting element 120G, the other electrode of the light-emitting element 120B, and the other electrode of the light-emitting element 120W are connected to the wiring VCOM2.

FIG. 15 illustrates an example in which the transistor M includes two gates between which a semiconductor is provided and the two gates are connected to each other. This structure can increase the amount of current flowing through the transistor M.

The wiring Ga1 and the wiring Ga2 can be supplied with a signal for changing the on/off state of the switch SW1. A predetermined potential can be supplied to the wiring VCOM1 and the wiring CSCOM. The wiring Sa1 and the wiring Sa2 can be supplied with a signal for controlling the orientation of liquid crystals included in the liquid crystal element 220R, the liquid crystal element 220G, the liquid crystal element 220B, and the liquid crystal element 220W. FIG. 15 shows the case where the wiring Sa1 can be supplied with a signal for controlling the orientation of liquid crystals included in the liquid crystal element 220R and the liquid crystal element 220B and the wiring Sa2 can be supplied with a signal for controlling the orientation of liquid crystals included in the liquid crystal element 220G and the liquid crystal element 220W.

The wiring Gb1 and the wiring Gb2 can be supplied with a signal for changing the on/off state of the switch SW2. The wiring VCOM2 and the wiring ANO can each be supplied with potentials having a difference large enough to make the light-emitting element 120R, the light-emitting element 120G, the light-emitting element 120B, and the light-emitting element 120W emit light. The wiring Sb1 and the wiring Sb2 can be supplied with a signal for changing the conduction state of the transistor M.

As for the pixel 12 shown in FIG. 15, for example, in the case where the pixel 12a is used to display an image, an image can be displayed by driving using a signal supplied to the wiring Ga1, the wiring Ga2, the wiring Sa1, and the wiring Sa2, and by optical modulation using the liquid crystal element 220R, the liquid crystal element 220G, the liquid crystal element 220B, and the liquid crystal element 220W. In the case where the pixel 12b is used to display an image, an image can be displayed by driving using a signal supplied to the wiring Gb1, the wiring Gb2, the wiring Sb1, and the wiring Sb2 and by light emission from the light-emitting element 120R, the light-emitting element 120G, the light-emitting element 120B, and the light-emitting element 120W. In the case where both of the pixels 12a and 12b are used to display an image, an image can be displayed by driving using signals supplied to the wiring Ga1, the wiring Ga2, the wiring Gb1, the wiring Gb2, the wiring Sa1, the wiring Sa2, the wiring Sb1, and the wiring Sb2.

In the example shown in FIG. 15, for example, display elements exhibiting red color can be used as the liquid crystal element 220R and the light-emitting element 120R, display elements exhibiting green color can be used as the liquid crystal element 220G and the light-emitting element 120G, display elements exhibiting blue color can be used as the liquid crystal element 220B and the light-emitting element 120B, and display elements exhibiting white color can be used as the liquid crystal element 220W and the light-emitting element 120W.

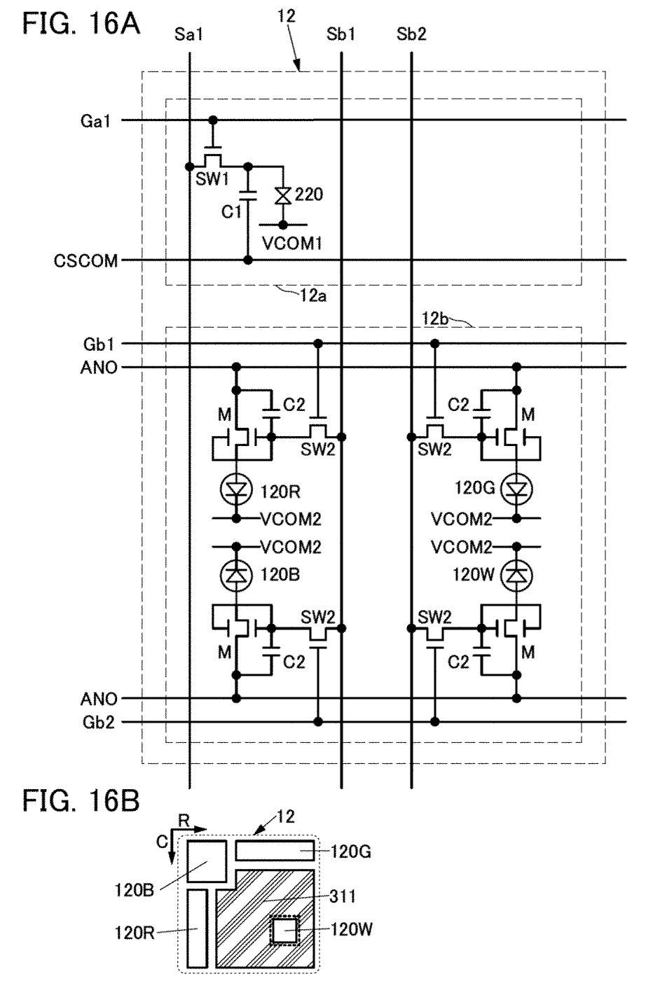

In the example shown in FIG. 15, one pixel 12 includes four liquid crystal elements 220 (the liquid crystal element 220R, the liquid crystal element 220G, the liquid crystal element 220B, and the liquid crystal element 220W) and four light-emitting elements 120 (the light-emitting element 120R, the light-emitting element 120G, the light-emitting element 120B, and the light-emitting element 120W), but one embodiment of the present invention is not limited thereto. FIG. 16A shows an example in which one pixel 12 includes one liquid crystal element 220 and four light-emitting elements 120 (the light-emitting element 120R, the light-emitting element 120G, the light-emitting element 120B, and the light-emitting element 120W). In this structure, in the case where a reflective liquid crystal element exhibiting white color is used as the liquid crystal element 220 and an image is displayed using the pixel 12a, for example, white color can be displayed with high reflectivity. Note that in the structure of the pixel 12 shown in FIG. 16A, the wiring Ga2 and the wiring Sa2 can be omitted.

FIG. 16B shows a structure example of the pixel 12 having the structure shown in FIG. 16A. The pixel 12 includes the light-emitting element 120W overlapping with the opening in the electrode 311 and the light-emitting elements 120R, 120G, and 120B located near the electrode 311. It is preferable that the light-emitting elements 120R, 120G, and 120B have almost the same light-emitting area.

The pixel 12 may have a structure in which the liquid crystal element 220W and the light-emitting element 120W are not provided in the structure shown in FIG. 15. The pixel 12 may have a structure in which the light-emitting element 120W is not provided in the structure shown in FIGS. 16A and 16B. These structures enable a reduction in the area of one pixel 12, so that the resolution of an image displayed by the display device 10 can be increased.

The number of elements such as transistors and capacitors of the pixel 12 can be changed as necessary or as appropriate. The number of wirings that are electrically connected to the pixel 12 can be changed as necessary or as appropriate.

### [Structure Example of Display Device]

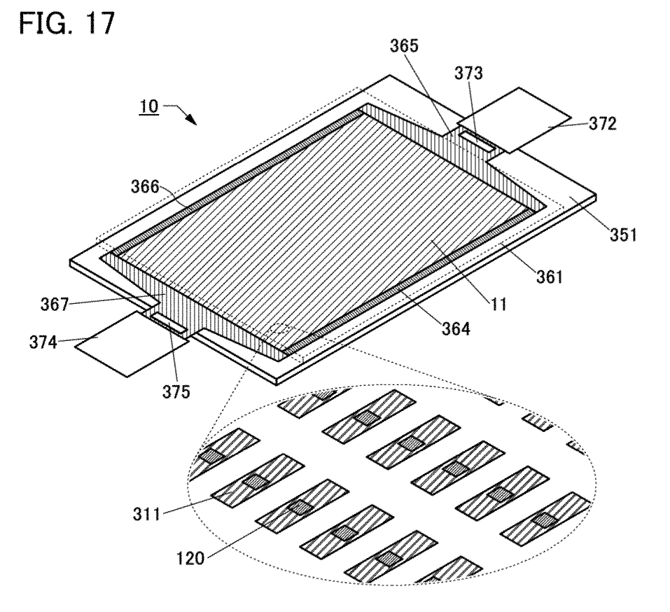

FIG. 17 is a schematic perspective view illustrating the display device 10 of one embodiment of the present invention. In the display device 10, a substrate 351 and a substrate 361 are bonded to each other. In FIG. 17, the substrate 361 is shown by a dashed line.

The display device 10 includes a circuit portion 364, a wiring 365, a circuit portion 366, a wiring 367, and the like in addition to the display portion 11 described in Embodiment 1. The substrate 351 is provided with the circuit portion 364, the wiring 365, the circuit portion 366, the wiring 367, the electrode 311 functioning as a pixel electrode, and the like. In FIG. 17, an IC 373, an FPC 372, an IC 375, and an FPC 374 are mounted on the substrate 351. Thus, the structure illustrated in FIG. 17 can be referred to as a display module including the display device 10, the IC 373, the FPC 372, the IC 375, and the FPC 374.

For the circuit portion 364, a circuit functioning as a gate driver circuit can be used, for example.

The wiring 365 has a function of supplying signals and electric power to the display portions and the circuit portion 364. The signals and electric power are input into the wiring 365 from the outside through the FPC 372 or from the IC 373.

FIG. 17 illustrates an example in which the IC 373 is provided on the substrate 351 by a chip on glass (COG) method or the like. As the IC 373, an IC functioning as a gate driver circuit, a source driver circuit, or the like can be used. Note that it is possible that the IC 373 is not provided, for example, when the display device 10 includes circuits functioning as a gate driver circuit and a source driver circuit and when the circuits functioning as a gate driver circuit and a source driver circuit are provided outside and signals for driving the display device 10 are input through the FPC 372. Alternatively, the IC 373 may be mounted on the FPC 372 by a chip on film (COF) method or the like.

FIG. 17 is an enlarged view of part of the display portion 11. Electrodes 311 included in a plurality of display elements are arranged in a matrix in the display portion 11. The electrode 311 has a function of reflecting visible light and functions as a reflective electrode of the liquid crystal element 220.

As illustrated in FIG. 17, the electrode 311 has an opening. The light-emitting element 120 is positioned closer to the substrate 351 than the electrode 311 is. Light is emitted from the light-emitting element 120 to the substrate 361 side through the opening in the electrode 311.

### [Cross-Sectional Structure Examples]

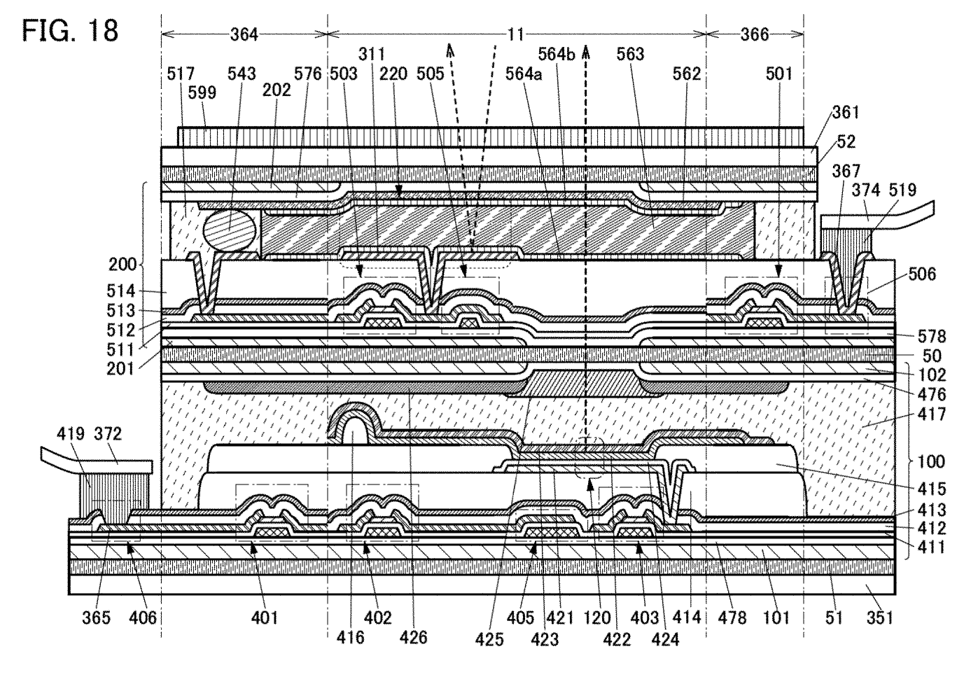

FIG. 18 illustrates an example of cross sections of part of a region including the FPC 372, part of a region including the circuit portion 364, part of a region including the display portion 11, part of a region including the circuit portion 366, and part of a region including the FPC 374 of the display device illustrated in FIG. 17.

The display device illustrated in FIG. 18 includes a structure in which the display panel 100 and the display panel 200 are stacked. The display panel 100 includes the resin layer 101 and the resin layer 102. The display panel 200 includes the resin layer 201 and the resin layer 202. The resin layer 102 and the resin layer 201 are bonded to each other with the adhesive layer 50. The resin layer 101 is bonded to the substrate 351 with the adhesive layer 51. The resin layer 202 is bonded to the substrate 361 with the adhesive layer 52.

### [Display Panel 100]

The display panel 100 includes the resin layer 101, an insulating layer 478, a plurality of transistors, a capacitor 405, an insulating layer 411, an insulating layer 412, an insulating layer 413, an insulating layer 414, an insulating layer 415, the light-emitting element 120, a spacer 416, an adhesive layer 417, a coloring layer 425, a light-blocking layer 426, an insulating layer 476, and the resin layer 102.

The resin layer 102 has an opening in a region overlapping with the light-emitting element 120.

The circuit portion 364 includes a transistor 401. The display portion 11 includes a transistor 402 and a transistor 403.

Each of the transistors includes a gate, the insulating layer 411, a semiconductor layer, a source, and a drain. The gate and the semiconductor layer overlap with each other with the insulating layer 411 provided therebetween. Part of the insulating layer 411 functions as a gate insulating layer, and another part of the insulating layer 411 functions as a dielectric of the capacitor 405. A conductive layer that functions as the source or the drain of the transistor 402 also functions as one electrode of the capacitor 405.

The transistors illustrated in FIG. 18 have bottom-gate structures. The transistor structures may be different between the circuit portion 364 and the display portion 11. The circuit portion 364 and the display portion 11 may each include a plurality of kinds of transistors.

The capacitor 405 includes a pair of electrodes and the dielectric therebetween. The capacitor 405 includes a conductive layer that is formed using the same material and the same process as the gates of the transistors, and a conductive layer that is formed using the same material and the same process as the sources and the drains of the transistors.

The insulating layer 412, the insulating layer 413, and the insulating layer 414 are each provided to cover the transistors and the like. There is no particular limitation on the number of the insulating layers covering the transistors and the like. The insulating layer 414 functions as a planarization layer. It is preferable that at least one of the insulating layer 412, the insulating layer 413, and the insulating layer 414 be formed using a material inhibiting diffusion of impurities such as water and hydrogen. Diffusion of impurities from the outside into the transistors can be effectively inhibited, leading to improved reliability of the display device.

In the case of using an organic material for the insulating layer 414, impurities such as moisture might enter the light-emitting element 120 or the like from the outside of the display device through the insulating layer 414 exposed at an end portion of the display device. Deterioration of the light-emitting element 120 due to the entry of impurities can lead to deterioration of the display device. For this reason, the insulating layer 414 is preferably not positioned at the end portion of the display device, as illustrated in FIG. 18. Since an insulating layer formed using an organic material is not positioned at the end portion of the display device in the structure of FIG. 18, entry of impurities into the light-emitting element 120 can be inhibited.

The light-emitting element 120 includes an electrode 421, an EL layer 422, and an electrode 423. The light-emitting element 120 may include an optical adjustment layer 424. The light-emitting element 120 has a top-emission structure with which light is emitted to the coloring layer 425 side.

The transistors, the capacitor, the wiring, and the like are positioned so as to overlap with a light-emitting region of the light-emitting element 120; accordingly, the aperture ratio of the display portion 11 can be increased.

One of the electrode 421 and the electrode 423 functions as an anode and the other functions as a cathode. When a voltage higher than the threshold voltage of the light-emitting element 120 is applied between the electrode 421 and the electrode 423, holes are injected to the EL layer 422 from the anode side and electrons are injected to the EL layer 422 from the cathode side. The injected electrons and holes are recombined in the EL layer 422 and a light-emitting substance contained in the EL layer 422 emits light.

The electrode 421 is electrically connected to the source or the drain of the transistor 403 directly or through a conductive layer. The electrode 421 functioning as a pixel electrode is provided for each light-emitting element 120. Two adjacent electrodes 421 are electrically insulated from each other by the insulating layer 415.

The EL layer 422 contains a light-emitting substance.

The electrode 423 functioning as a common electrode is shared by a plurality of light-emitting elements 120. A fixed potential is supplied to the electrode 423.

The light-emitting element 120 overlaps with the coloring layer 425 with the adhesive layer 417 provided therebetween. The spacer 416 overlaps with the light-blocking layer 426 with the adhesive layer 417 provided therebetween. Although FIG. 18 illustrates the case where a space is provided between the electrode 423 and the light-blocking layer 426, the electrode 423 and the light-blocking layer 426 may be in contact with each other. Although the spacer 416 is provided on the substrate 351 side in the structure illustrated in FIG. 18, the spacer 416 may be provided on the substrate 361 side (e.g., in a position closer to the substrate 361 than the light-blocking layer 426).

Owing to the combination of a color filter (the coloring layer 425) and a microcavity structure (the optical adjustment layer 424), light with high color purity can be extracted from the display device. The thickness of the optical adjustment layer 424 is varied depending on the color of the pixel.

The coloring layer 425 is a coloring layer that transmits light in a specific wavelength range. For example, a color filter for transmitting light in a red, green, blue, or yellow wavelength range can be used.

Note that one embodiment of the present invention is not limited to a color filter method, and a separate coloring method, a color conversion method, a quantum dot method, and the like may be employed.

The light-blocking layer 426 is provided between the adjacent coloring layers 425. The light-blocking layer 426 blocks light emitted from the adjacent light-emitting element 120 to inhibit color mixture between the adjacent light-emitting elements 120. Here, the coloring layer 425 is provided such that its end portion overlaps with the light-blocking layer 426, whereby light leakage can be reduced. For the light-blocking layer 426, a material that blocks light emitted from the light-emitting element 120 can be used. Note that it is preferable to provide the light-blocking layer 426 in a region other than the display portion 11, such as the circuit portion 364, in which case undesired leakage of guided light or the like can be inhibited.

The insulating layer 478 is formed on a surface of the resin layer 101. The insulating layer 476 is formed on a surface of the resin layer 102. The insulating layer 476 and the insulating layer 478 are preferably highly resistant to moisture. The light-emitting element 120, the transistors, and the like are preferably provided between a pair of insulating layers with high resistance to moisture, in which case entry of impurities such as water into these elements can be inhibited, leading to an increase in the reliability of the display device.

As an insulating film with high resistance to moisture, a film containing nitrogen and silicon (e.g., a silicon nitride film or a silicon nitride oxide film), a film containing nitrogen and aluminum (e.g., an aluminum nitride film), or the like can be used. Alternatively, a silicon oxide film, a silicon oxynitride film, an aluminum oxide film, or the like can be used.

For example, the moisture vapor transmittance of the insulating film with high resistance to moisture is lower than or equal to 1×10⁻⁵ [g/(m²·day)], preferably lower than or equal to 1×10⁻⁶ [g/(m²·day)], further preferably lower than or equal to 1×10⁻⁷ [g/(m²·day)], and still further preferably lower than or equal to 1×10⁸ [g/(m²·day)].

A connection portion 406 includes the wiring 365. The wiring 365 can be formed using the same material and the same process as those of the sources and the drains of the transistors. The connection portion 406 is electrically connected to an external input terminal through which a signal and a potential from the outside are transmitted to the circuit portion 364. Here, an example in which the FPC 372 is provided as the external input terminal is described. The FPC 372 is electrically connected to the connection portion 406 through a connection layer 419.

The connection layer 419 can be formed using any of various kinds of anisotropic conductive films (ACF), anisotropic conductive pastes (ACP), and the like.

The above is the description of the display panel 100.

### [Display Panel 200]

The display panel 200 is a liquid crystal display device employing a vertical electric field mode.

The display panel 200 includes the resin layer 201, an insulating layer 578, a plurality of transistors, a capacitor 505, the wiring 367, an insulating layer 511, an insulating layer 512, an insulating layer 513, an insulating layer 514, the liquid crystal element 220, an alignment film 564a, an alignment film 564b, an adhesive layer 517, an insulating layer 576, and the resin layer 202.

The resin layer 201 and the resin layer 202 are bonded to each other with the adhesive layer 517. Liquid crystal 563 is sealed in a region surrounded by the resin layer 201, the resin layer 202, and the adhesive layer 517. A polarizing plate 599 is positioned on an outer surface of the substrate 361.

Furthermore, an opening overlapping with the light-emitting element 120 is formed in the resin layer 201. An opening overlapping with the liquid crystal element 220 and the light-emitting element 120 is formed in the resin layer 202.

The liquid crystal element 220 includes the electrode 311, an electrode 562, and the liquid crystal 563. The electrode 311 functions as a pixel electrode. The electrode 562 functions as a common electrode. Alignment of the liquid crystal 563 can be controlled with an electric field generated between the electrode 311 and the electrode 562. The alignment film 564a is provided between the liquid crystal 563 and the electrode 311. The alignment film 564b is provided between the liquid crystal 563 and the electrode 562.

The resin layer 202 is provided with the insulating layer 576, the electrode 562, the alignment film 564b, and the like.

The resin layer 201 is provided with the electrode 311, the alignment film 564a, a transistor 501, a transistor 503, the capacitor 505, a connection portion 506, the wiring 367, and the like.

Insulating layers such as the insulating layer 511, the insulating layer 512, the insulating layer 513, and the insulating layer 514 are provided over the resin layer 201.

Note that a portion of the conductive layer functioning as a source or a drain of the transistor 503 which is not electrically connected to the electrode 311 may function as part of a signal line. The conductive layer functioning as a gate of the transistor 503 may function as part of a scan line.

FIG. 18 illustrates a structure without a coloring layer as an example of the display portion 11. Thus, the liquid crystal element 220 is an element that performs monochrome display.

FIG. 18 illustrates an example of the circuit portion 366 in which the transistor 501 is provided.

A material inhibiting diffusion of impurities such as water and hydrogen is preferably used for at least one of the insulating layer 512 and the insulating layer 513 which cover the transistors.

The electrode 311 is provided over the insulating layer 514. The electrode 311 is electrically connected to one of the source and the drain of the transistor 503 through an opening formed in the insulating layer 514, the insulating layer 513, the insulating layer 512, and the like. The electrode 311 is electrically connected to one electrode of the capacitor 505.

In the case where the display panel 200 is a reflective liquid crystal display device, a conductive material that reflects visible light is used for the electrode 311 and a conductive material that transmits visible light is used for the electrode 562. In the case where the display panel 200 is a transmissive liquid crystal display device, a conductive material that transmits visible light is used for the electrode 311.

For example, a material containing one or more of indium (In), zinc (Zn), and tin (Sn) is preferably used as the conductive material that transmits visible light. Specifically, indium oxide, indium tin oxide (ITO), indium zinc oxide, indium oxide containing tungsten oxide, indium zinc oxide containing tungsten oxide, indium oxide containing titanium oxide, indium tin oxide containing titanium oxide, indium tin oxide containing silicon oxide (ITSO), zinc oxide, and zinc oxide containing gallium are given, for example. Note that a film including graphene can be used as well. The film including graphene can be formed, for example, by reducing a film containing graphene oxide.

Examples of the conductive material that reflects visible light include aluminum, silver, and an alloy including any of these metal materials. A metal material such as gold, platinum, tungsten, chromium, molybdenum, iron, cobalt, copper, or palladium, or an alloy including any of these metal materials can also be used. Lanthanum, neodymium, germanium, or the like may be added to the metal material or the alloy. Furthermore, an alloy containing aluminum (an aluminum alloy) such as an alloy of aluminum and titanium, an alloy of aluminum and nickel, an alloy of aluminum and neodymium, or an alloy of aluminum, nickel, and lanthanum (Al—Ni—La), or an alloy containing silver such as an alloy of silver and copper, an alloy of silver, palladium, and copper (also referred to as Ag—Pd—Cu or APC), or an alloy of silver and magnesium may be used.

As the polarizing plate 599, a linear polarizing plate or a circularly polarizing plate can be used. An example of a circularly polarizing plate is a stack including a linear polarizing plate and a quarter-wave retardation plate. Such a structure can reduce reflection of external light. The cell gap, alignment, drive voltage, and the like of the liquid crystal element 220 are controlled in accordance with the kind of the polarizing plate 599 so that desirable contrast is obtained.

The electrode 562 is electrically connected to a conductive layer on the resin layer 201 side through a connector 543 in a portion close to an end portion of the resin layer 202. Thus, a potential or a signal can be supplied to the electrode 562 from the FPC 374, an IC, or the like placed on the resin layer 201 side.

As the connector 543, a conductive particle can be used, for example. As the conductive particle, a particle of an organic resin, silica, or the like coated with a metal material can be used. It is preferable to use nickel or gold as the metal material because contact resistance can be decreased. It is also preferable to use a particle coated with layers of two or more kinds of metal materials, such as a particle coated with nickel and further with gold. As the connector 543, a material capable of elastic deformation or plastic deformation is preferably used. As illustrated in FIG. 18, the connector 543, which is the conductive particle, has a shape that is vertically crushed in some cases. With the crushed shape, the contact area between the connector 543 and a conductive layer electrically connected to the connector 543 can be increased, thereby reducing contact resistance and suppressing the generation of problems such as disconnection.

The connector 543 is preferably provided so as to be covered with the adhesive layer 517. For example, the connectors 543 are dispersed in the adhesive layer 517 before curing of the adhesive layer 517.

The connection portion 506 is provided in a region near an end portion of the resin layer 201. The connection portion 506 is electrically connected to the FPC 374 through the connection layer 519. In the example of the structure illustrated in FIG. 18, the connection portion 506 is formed by stacking part of the wiring 367 and a conductive layer that is obtained by processing the same conductive film as the electrode 311.

The above is the description of the display panel 200.

### [Components]

The above components will be described below.

### [Substrate]

A material having a flat surface can be used as the substrate included in the display panel. The substrate on the side from which light from the display element is extracted is formed using a material transmitting the light. For example, a material such as glass, quartz, ceramics, sapphire, or an organic resin can be used.

The weight and thickness of the display panel can be reduced by using a thin substrate. A flexible display panel can be obtained by using a substrate that is thin enough to have flexibility.

Since the substrate through which light is not extracted does not need to have a light-transmitting property, a metal substrate or the like can be used, other than the above-mentioned substrates. A metal substrate, which has high thermal conductivity, is preferable because it can easily conduct heat to the whole substrate and accordingly can inhibit a local temperature rise in the display panel. To obtain flexibility and bendability, the thickness of a metal substrate is preferably greater than or equal to 10 μm and less than or equal to 400 μm and further preferably greater than or equal to 20 μm and less than or equal to 50 μm.

Although there is no particular limitation on a material of a metal substrate, it is favorable to use, for example, a metal such as aluminum, copper, and nickel, an aluminum alloy, or an alloy such as stainless steel.

It is possible to use a substrate subjected to insulation treatment, e.g., a metal substrate whose surface is oxidized or provided with an insulating film. The insulating film may be formed by, for example, a coating method such as a spin-coating method or a dipping method, an electrodeposition method, an evaporation method, or a sputtering method. An oxide film may be formed on the substrate surface by exposure to or heating in an oxygen atmosphere or by an anodic oxidation method or the like.

Examples of the material having flexibility and transmitting visible light include glass which is thin enough to have flexibility, polyester resins such as polyethylene terephthalate (PET) and polyethylene naphthalate (PEN), a polyacrylonitrile resin, a polyimide resin, a polymethyl methacrylate resin, a polycarbonate (PC) resin, a polyethersulfone (PES) resin, a polyamide resin, a cycloolefin resin, a polystyrene resin, a polyamide imide resin, a polyvinyl chloride resin, and a polytetrafluoroethylene (PTFE) resin. It is particularly preferable to use a material with a low thermal expansion coefficient, for example, a material with a thermal expansion coefficient lower than or equal to 30×10⁻⁶ /K, such as a polyamide imide resin, a polyimide resin, or PET. A substrate in which a glass fiber is impregnated with an organic resin or a substrate whose thermal expansion coefficient is reduced by mixing an inorganic filler with an organic resin can also be used. A substrate using such a material is lightweight, and thus a display panel using the substrate can also be lightweight.

In the case where a fibrous body is included in the above material, a high-strength fiber of an organic compound or an inorganic compound is used as the fibrous body. The high-strength fiber is specifically a fiber with a high tensile elastic modulus or a fiber with a high Young's modulus. Typical examples thereof include a polyvinyl alcohol-based fiber, a polyester-based fiber, a polyamide-based fiber, a polyethylene-based fiber, an aramid-based fiber, a polyparaphenylene benzobisoxazole fiber, a glass fiber, and a carbon fiber. As the glass fiber, a glass fiber using E glass, S glass, D glass, Q glass, or the like can be used. These fibers may be used in a state of a woven or nonwoven fabric, and a structure body in which this fibrous body is impregnated with a resin and the resin is cured may be used as the flexible substrate. The structure body including the fibrous body and the resin is preferably used as the flexible substrate, in which case the reliability against bending or breaking due to local pressure can be increased.

Alternatively, glass, metal, or the like that is thin enough to have flexibility can be used as the substrate. Alternatively, a composite material where glass and a resin material are bonded to each other with an adhesive layer may be used.

A hard coat layer (e.g., a silicon nitride layer and an aluminum oxide layer) by which a surface of a display panel is protected from damage, a layer (e.g., an aramid resin layer) that can disperse pressure, or the like may be stacked over the flexible substrate. Furthermore, to suppress a decrease in lifetime of the display element due to moisture and the like, an insulating film with low water permeability may be stacked over the flexible substrate. For example, an inorganic insulating material such as silicon nitride, silicon oxynitride, silicon nitride oxide, aluminum oxide, or aluminum nitride can be used.

The substrate may be formed by stacking a plurality of layers. When a glass layer is used, a barrier property against water and oxygen can be improved and thus a highly reliable display panel can be provided.

### [Transistor]

The transistor includes a conductive layer functioning as a gate electrode, a semiconductor layer, a conductive layer functioning as a source electrode, a conductive layer functioning as a drain electrode, and an insulating layer functioning as a gate insulating layer. In the above, a bottom-gate transistor is used.

Note that there is no particular limitation on the structure of the transistor included in the display device of one embodiment of the present invention. For example, a planar transistor, a staggered transistor, or an inverted staggered transistor can be used. A top-gate transistor or a bottom-gate transistor may also be used. Gate electrodes may be provided above and below a channel.

There is no particular limitation on the crystallinity of a semiconductor material used for the transistors, and an amorphous semiconductor or a semiconductor having crystallinity (a microcrystalline semiconductor, a polycrystalline semiconductor, a single crystal semiconductor, or a semiconductor partly including crystal regions) may be used. It is preferable that a semiconductor having crystallinity be used, in which case deterioration of the transistor characteristics can be suppressed.

As a semiconductor material used for the transistors, a metal oxide can be used. A typical example thereof is a metal oxide containing indium.

In particular, a semiconductor material having a wider band gap and a lower carrier density than silicon is preferably used because off-state current of the transistor can be reduced.

A transistor with a metal oxide having a larger band gap than silicon has a low off-state current; therefore, charges stored in a capacitor that is series-connected to the transistor can be held for a long time. When such a transistor is used for a pixel, operation of a driver circuit can be stopped while a gray scale of each pixel is maintained. As a result, a display device with extremely low power consumption can be achieved.

The semiconductor layer preferably includes, for example, a film represented by an In-M-Zn-based oxide that contains at least indium, zinc, and M (a metal such as gallium, aluminum, silicon, titanium, germanium, boron, yttrium, copper, vanadium, beryllium, iron, nickel, zirconium, molybdenum, lanthanum, cerium, neodymium, hafnium, tantalum, tungsten, or magnesium). In order to reduce variations in electrical characteristics of the transistor including the metal oxide, the oxide semiconductor preferably contains a stabilizer in addition to indium, zinc, and M.

Examples of the stabilizer, including metals that can be used as M, are lanthanoid such as praseodymium, samarium, europium, gadolinium, terbium, dysprosium, holmium, erbium, thulium, ytterbium, and lutetium.

As a metal oxide included in the semiconductor layer, any of the following can be used, for example: an In—Ga—Zn-based oxide, an In—Al—Zn-based oxide, In—Si—Zn-based oxide, In—Ti—Zn-based oxide, In—Ge—Zn-based oxide, In—B—Zn-based oxide, In—Y—Zn-based oxide, In—Cu—Zn-based oxide, In—V—Zn-based oxide, In—Be—Zn-based oxide, In—Fe—Zn-based oxide, In—Ni—Zn-based oxide, In—Zr—Zn-based oxide, In—Mo—Zn-based oxide, In—Ta—Zn-based oxide, In—W—Zn-based oxide, In—Mg—Zn-based oxide, an In—Sn—Zn-based oxide, an In—Hf—Zn-based oxide, an In—La—Zn-based oxide, an In—Ce—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, an In—Lu—Zn-based oxide, an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, and an In—Hf—Al—Zn-based oxide.

Note that here, an “In—Ga—Zn-based oxide” means an oxide containing In, Ga, and Zn as its main components, and there is no limitation on the ratio of In:Ga:Zn. The In—Ga—Zn-based oxide may contain another metal element in addition to In, Ga, and Zn.

The semiconductor layer and the conductive layer may include the same metal elements contained in the above oxides. The use of the same metal elements for the semiconductor layer and the conductive layer can reduce the manufacturing cost. For example, when metal oxide targets with the same metal composition are used, the manufacturing cost can be reduced, and the same etching gas or the same etchant can be used in processing the semiconductor layer and the conductive layer. Note that even when the semiconductor layer and the conductive layer include the same metal elements, they have different compositions in some cases. For example, a metal element in a film is released during the manufacturing process of the transistor and the capacitor, which might result in different metal compositions.

The energy gap of the metal oxide contained in the semiconductor layer is preferably 2 eV or more, further preferably 2.5 eV or more, and still further preferably 3 eV or more. With the use of a metal oxide having such a wide energy gap, the off-state current of the transistor can be reduced.

In the case where the metal oxide contained in the semiconductor layer contains an In-M-Zn-based oxide, it is preferable that the atomic ratio of metal elements of a sputtering target used for forming a film of the In-M-Zn-based oxide satisfy In and Zn≧As the atomic ratio of metal elements of such a sputtering target, InM:Zn=1:1:1, In:M:Zn=1:1:1.2, In:M:Zn=3:1:2, In:M:Zn=4:2:3, In:M:Zn=4:2:4.1, In:M:Zn=5:1:6, In:M:Zn=5:1:7, In:M:Zn=5:1:8, and the like are preferable. Note that the atomic ratio of metal elements in the formed semiconductor layer varies from the above atomic ratio of metal elements of the sputtering target within a range of ±40%.

The bottom-gate transistor described in this embodiment is preferable because the number of manufacturing steps can be reduced. When a metal oxide, which can be formed at a lower temperature than polycrystalline silicon, is used, materials with low heat resistance can be used for a wiring, an electrode, or a substrate below the semiconductor layer, so that the range of materials can be widened. For example, an extremely large glass substrate can be favorably used.

### [Conductive Layer]

As materials for a gate, a source, and a drain of a transistor, and a wiring or an electrode included in a display device, any of metals such as aluminum, titanium, chromium, nickel, copper, yttrium, zirconium, molybdenum, silver, tantalum, and tungsten, or an alloy containing any of these metals as its main component can be used. A single-layer structure or multi-layer structure including a film containing any of these materials can be used. For example, the following structures can be given: a single-layer structure of an aluminum film containing silicon, a two-layer structure in which an aluminum film is stacked over a titanium film, a two-layer structure in which an aluminum film is stacked over a tungsten film, a two-layer structure in which a copper film is stacked over a copper-magnesium-aluminum alloy film, a two-layer structure in which a copper film is stacked over a titanium film, a two-layer structure in which a copper film is stacked over a tungsten film, a three-layer structure in which a titanium film or a titanium nitride film, an aluminum film or a copper film, and a titanium film or a titanium nitride film are stacked in this order, and a three-layer structure in which a molybdenum film or a molybdenum nitride film, an aluminum film or a copper film, and a molybdenum film or a molybdenum nitride film are stacked in this order. Note that an oxide such as indium oxide, tin oxide, or zinc oxide may be used. Copper containing manganese is preferably used because controllability of a shape by etching is increased.

As a light-transmitting conductive material, a conductive oxide such as indium oxide, indium tin oxide, indium zinc oxide, zinc oxide, or zinc oxide to which gallium is added, or graphene can be used. Alternatively, a metal material such as gold, silver, platinum, magnesium, nickel, tungsten, chromium, molybdenum, iron, cobalt, copper, palladium, or titanium, or an alloy material containing any of these metal materials can be used. Alternatively, a nitride of the metal material (e.g., titanium nitride) or the like may be used. In the case of using the metal material or the alloy material (or the nitride thereof), the conductive layer may be formed thin so as to have a light-transmitting property. Alternatively, a stacked film of any of the above materials can be used as the conductive layer. For example, a stacked film of indium tin oxide and an alloy of silver and magnesium is preferably used because the conductivity can be increased. They can also be used for conductive layers such as a variety of wirings and electrodes included in a display device, and a conductive layer (e.g., a conductive layer functioning as a pixel electrode or a common electrode) included in a display element.

### [Insulating Layer]

Examples of an insulating material that can be used for the insulating layers include a polyimide resin, an acrylic resin, an epoxy resin, a silicone resin, or the like, and an inorganic insulating material such as silicon oxide, silicon oxynitride, silicon nitride oxide, silicon nitride, or aluminum oxide.

The light-emitting element is preferably provided between a pair of insulating films with low water permeability, in which case entry of impurities such as water into the light-emitting element can be prevented suppressed. Thus, a decrease in device reliability can be suppressed.

As an insulating film with low water permeability, a film containing nitrogen and silicon (e.g., a silicon nitride film or a silicon nitride oxide film), a film containing nitrogen and aluminum (e.g., an aluminum nitride film), or the like can be used. Alternatively, a silicon oxide film, a silicon oxynitride film, an aluminum oxide film, or the like can be used.

For example, the water vapor transmittance of the insulating film with low water permeability is lower than or equal to 1×10⁻⁵ [g/(m²·day)], preferably lower than or equal to 1×10⁶ [g/(m²·day)], further preferably lower than or equal to 1×10⁷ [g/(m²·day)], and still further preferably lower than or equal to 1×10⁻⁸ [g/(m²·day)].

### [Display Element]

As a display element included in the pixel 12a on the display surface side, an element which performs display by reflecting external light can be used, for example. Such an element does not include a light source and thus power consumption in display can be significantly reduced. As the display element included in the pixel 12a, a reflective liquid crystal element can be typically used. As the display element included in the pixel 12a, an element using a microcapsule method, an electrophoretic method, an electrowetting method, an Electronic Liquid Powder (registered trademark) method, or the like can be used other than a Micro Electro Mechanical Systems (MEMS) shutter element or an optical interference type MEMS element.

As the display element included in the pixel 12b, an element that includes a light source and performs display using light from the light source can be used. The luminance and the chromaticity of light emitted from such a pixel are not affected by external light as described in Embodiment 1, and therefore, an image with high color reproducibility (a wide color gamut) and a high contrast, i.e., a high-quality image can be displayed. As the display element included in the pixel 12b, a self-luminous light-emitting element such as an OLED, an LED, a QLED, an IEL element, or a semiconductor laser can be used as described above, for example. A combination of a backlight as a light source and a transmissive liquid crystal element that controls the amount of transmitted light emitted from a backlight may be used as the display element included in the pixel 12b.

### [Liquid Crystal Element]

The liquid crystal element can employ, for example, a vertical alignment (VA) mode. Examples of the vertical alignment mode include a multi-domain vertical alignment (MVA) mode, a patterned vertical alignment (PVA) mode, and an advanced super view (ASV) mode.

The liquid crystal element can employ a variety of modes. For example, a liquid crystal element using, instead of a VA mode, a twisted nematic (TN) mode, an in-plane switching (IPS) mode, a fringe field switching (FFS) mode, an axially symmetric aligned micro-cell (ASM) mode, an optically compensated birefringence (OCB) mode, a ferroelectric liquid crystal (FLC) mode, an antiferroelectric liquid crystal (AFLC) mode, or the like can be used.

The liquid crystal element controls transmission or non-transmission of light utilizing an optical modulation action of liquid crystal. Note that optical modulation action of liquid crystal is controlled by an electric field applied to the liquid crystal (including a horizontal electric field, a vertical electric field, or an oblique electric field). As the liquid crystal used for the liquid crystal element, thermotropic liquid crystal, low-molecular liquid crystal, high-molecular liquid crystal, polymer-dispersed liquid crystal (PDLC), ferroelectric liquid crystal, anti-ferroelectric liquid crystal, or the like can be used. These liquid crystal materials exhibit a cholesteric phase, a smectic phase, a cubic phase, a chiral nematic phase, an isotropic phase, or the like depending on conditions.

As the liquid crystal material, either of a positive liquid crystal and a negative liquid crystal may be used, and an appropriate liquid crystal material can be used depending on the mode or design to be used.

In addition, to control the alignment of the liquid crystal, an alignment film can be provided. Alternatively, when a horizontal electric field mode is employed, a liquid crystal exhibiting a blue phase for which an alignment film is unnecessary may be used. A blue phase is one of liquid crystal phases, which is generated just before a cholesteric phase changes into an isotropic phase while the temperature of cholesteric liquid crystal is increased. Since the blue phase appears only in a narrow temperature range, a liquid crystal composition in which several weight percent or more of a chiral material is mixed is used for the liquid crystal layer in order to improve the temperature range. The liquid crystal composition which includes liquid crystal exhibiting a blue phase and a chiral material has a short response time and optical isotropy. In addition, the liquid crystal composition which includes liquid crystal exhibiting a blue phase and a chiral material does not need alignment treatment and has a small viewing angle dependence. An alignment film does not need to be provided and rubbing treatment is thus not necessary; accordingly, electrostatic discharge damage caused by the rubbing treatment can be prevented and defects and damage of the liquid crystal display device in the manufacturing process can be reduced.

In one embodiment of the present invention, in particular, a reflective liquid crystal element can be used. Note that a transmissive liquid crystal element, a semi-transmissive liquid crystal element, or the like may be used. Furthermore, a non-light-emitting display element other than a liquid crystal element may be used.

In the case where the reflective liquid crystal element is used, the polarizing plate is provided on the display surface side. Separately, a light diffusion plate is preferably provided on the display surface side to improve visibility.

### [Light-Emitting Element]

As the light-emitting element, a self-luminous element can be used as described above, and an element whose luminance is controlled by current or voltage is included in the category of the light-emitting element.

In one embodiment of the present invention, in particular, the light-emitting element preferably has a top emission structure. A conductive film that transmits visible light is used as the electrode through which light is extracted. A conductive film that reflects visible light is preferably used as the electrode through which light is not extracted.

In the case where the light-emitting element is an element including an EL layer, such as an OLED or an IEL, the EL layer includes at least a light-emitting layer. In addition to the light-emitting layer, the EL layer may further include one or more layers containing any of a substance with a high hole-injection property, a substance with a high hole-transport property, a hole-blocking material, a substance with a high electron-transport property, a substance with a high electron-injection property, a substance with a bipolar property (a substance with a high electron- and hole-transport property), and the like.

Either a low molecular compound or a high molecular compound can be used for the EL layer, and an inorganic compound may also be used. The layers included in the EL layer can be formed by any of the following methods: an evaporation method (including a vacuum evaporation method), a transfer method, a printing method, an inkjet method, a coating method, and the like.

When a voltage higher than the threshold voltage of the light-emitting element is applied between the anode and the cathode, holes are injected to the EL layer from the anode side and electrons are injected to the EL layer from the cathode side. The injected electrons and holes are recombined in the EL layer and a light-emitting substance contained in the EL layer emits light.

In the case where a light-emitting element emitting white light is used as the light-emitting element, the EL layer preferably contains two or more kinds of light-emitting substances. For example, light-emitting substances are selected so that two or more light-emitting substances emit complementary colors to obtain white light emission. Specifically, it is preferable to contain two or more light-emitting substances selected from light-emitting substances emitting light of red (R), green (G), blue (B), yellow (Y), orange (0), and the like and light-emitting substances emitting light containing two or more of spectral components of R, G, and B. The light-emitting element preferably emits light with a spectrum having two or more peaks in the wavelength range of a visible light region (e.g., greater than or equal to 350 nm and less than or equal to 750 nm). An emission spectrum of a material emitting light having a peak in the wavelength range of a yellow light preferably includes spectral components also in the wavelength range of a green light and a red light.

A light-emitting layer containing a light-emitting material emitting light of one color and a light-emitting layer containing a light-emitting material emitting light of another color are preferably stacked in the EL layer. For example, the plurality of light-emitting layers in the EL layer may be stacked in contact with each other or may be stacked with a region not including any light-emitting material therebetween. For example, between a fluorescent layer and a phosphorescent layer, a region containing the same material as one in the fluorescent layer or phosphorescent layer (for example, a host material or an assist material) and no light-emitting material may be provided. This facilitates the manufacture of the light-emitting element and reduces the drive voltage.

The light-emitting element may be a single element including one EL layer or a tandem element in which a plurality of EL layers are stacked with a charge generation layer therebetween.

Note that the aforementioned light-emitting layer and layers containing a substance with a high hole-injection property, a substance with a high hole-transport property, a substance with a high electron-transport property, a substance with a high electron-injection property, and a substance with a bipolar property may include an inorganic compound such as a quantum dot or a high molecular compound (e.g., an oligomer, a dendrimer, and a polymer). For example, used for the light-emitting layer, the quantum dot can serve as a light-emitting material. A light-emitting element including a quantum dot in a light-emitting layer is referred to as a QLED.

A quantum dot is a semiconductor nanocrystal with a size of several nanometers and contains approximately 1×10³ to 1×10⁶ atoms. Since energy shift of quantum dots depends on their size, quantum dots made of the same substance emit light with different wavelengths depending on their size; thus, emission wavelengths can be easily adjusted by changing the size of quantum dots.

Since a quantum dot has an emission spectrum with a narrow peak, emission with high color purity can be obtained. In addition, a quantum dot is said to have a theoretical external quantum efficiency of approximately 100%, which far exceeds that of a fluorescent organic compound, i.e., 25%, and is comparable to that of a phosphorescent organic compound. Therefore, a quantum dot can be used as a light-emitting material to obtain a light-emitting element having high light-emitting efficiency. Furthermore, since a quantum dot which is an inorganic compound has high inherent stability, a light-emitting element which is favorable also in terms of lifetime can be obtained.

Examples of a material of a quantum dot include a Group 14 element in the periodic table, a Group 15 element in the periodic table, a Group 16 element in the periodic table, a compound of a plurality of Group 14 elements in the periodic table, a compound of an element belonging to any of Groups 4 to 14 in the periodic table and a Group 16 element in the periodic table, a compound of a Group 2 element in the periodic table and a Group 16 element in the periodic table, a compound of a Group 13 element in the periodic table and a Group 15 element in the periodic table, a compound of a Group 13 element in the periodic table and a Group 17 element in the periodic table, a compound of a Group 14 element in the periodic table and a Group 15 element in the periodic table, a compound of a Group 11 element in the periodic table and a Group 17 element in the periodic table, iron oxides, titanium oxides, spinel chalcogenides, and semiconductor clusters.

Specific examples include, but are not limited to, cadmium selenide; cadmium sulfide; cadmium telluride; zinc selenide; zinc oxide; zinc sulfide; zinc telluride; mercury sulfide; mercury selenide; mercury telluride; indium arsenide; indium phosphide; gallium arsenide; gallium phosphide; indium nitride; gallium nitride; indium antimonide; gallium antimonide; aluminum phosphide; aluminum arsenide; aluminum antimonide; lead selenide; lead telluride; lead sulfide; indium selenide; indium telluride; indium sulfide; gallium selenide; arsenic sulfide; arsenic selenide; arsenic telluride; antimony sulfide; antimony selenide; antimony telluride; bismuth sulfide; bismuth selenide; bismuth telluride; silicon; silicon carbide; germanium; tin; selenium; tellurium; boron; carbon; phosphorus; boron nitride; boron phosphide; boron arsenide; aluminum nitride; aluminum sulfide; barium sulfide; barium selenide; barium telluride; calcium sulfide; calcium selenide; calcium telluride; beryllium sulfide; beryllium selenide; beryllium telluride; magnesium sulfide; magnesium selenide; germanium sulfide; germanium selenide; germanium telluride; tin sulfide; tin selenide; tin telluride; lead oxide; copper fluoride; copper chloride; copper bromide; copper iodide; copper oxide; copper selenide; nickel oxide; cobalt oxide; cobalt sulfide; triiron tetraoxide; iron sulfide; manganese oxide; molybdenum sulfide; vanadium oxide; tungsten oxide; tantalum oxide; titanium oxide; zirconium oxide; silicon nitride; germanium nitride; aluminum oxide; barium titanate; a compound of selenium, zinc, and cadmium; a compound of indium, arsenic, and phosphorus; a compound of cadmium, selenium, and sulfur; a compound of cadmium, selenium, and tellurium; a compound of indium, gallium, and arsenic; a compound of indium, gallium, and selenium; a compound of indium, selenium, and sulfur; a compound of copper, indium, and sulfur; and combinations thereof. What is called an alloyed quantum dot, whose composition is represented by a given ratio, may be used. For example, an alloyed quantum dot of cadmium, selenium, and sulfur is a means effective in obtaining blue light because the emission wavelength can be changed by changing the content ratio of elements.

As the quantum dot, any of a core-type quantum dot, a core-shell quantum dot, a core-multishell quantum dot, and the like can be used. Note that when a core is covered with a shell formed of another inorganic material having a wider band gap, the influence of defects and dangling bonds existing at the surface of a nanocrystal can be reduced. Since such a structure can significantly improve the quantum efficiency of light emission, it is preferable to use a core-shell or core-multishell quantum dot. Examples of the material of a shell include zinc sulfide and zinc oxide.

Quantum dots have a high proportion of surface atoms and thus have high reactivity and easily cohere together. For this reason, it is preferable that a protective agent be attached to, or a protective group be provided at the surfaces of quantum dots. The attachment of the protective agent or the provision of the protective group can prevent cohesion and increase solubility in a solvent. It can also reduce reactivity and improve electrical stability. Examples of the protective agent (or the protective group) include polyoxyethylene alkyl ethers such as polyoxyethylene lauryl ether, polyoxyethylene stearyl ether, and polyoxyethylene oleyl ether; trialkylphosphines such as tripropylphosphine, tributylphosphine, trihexylphosphine, and trioctylphoshine; polyoxyethylene alkylphenyl ethers such as polyoxyethylene n-octylphenyl ether and polyoxyethylene n-nonylphenyl ether; tertiary amines such as tri(n-hexyl)amine, tri(n-octyl)amine, and tri(n-decyl)amine; organophosphorus compounds such as tripropylphosphine oxide, tributylphosphine oxide, trihexylphosphine oxide, trioctylphosphine oxide, and tridecylphosphine oxide; polyethylene glycol diesters such as polyethylene glycol dilaurate and polyethylene glycol distearate; organic nitrogen compounds such as nitrogen-containing aromatic compounds, e.g., pyridines, lutidines, collidines, and quinolines; aminoalkanes such as hexylamine, octylamine, decylamine, dodecylamine, tetradecylamine, hexadecylamine, and octadecylamine; dialkylsulfides such as dibutylsulfide; dialkylsulfoxides such as dimethylsulfoxide and dibutylsulfoxide; organic sulfur compounds such as sulfur-containing aromatic compounds, e.g., thiophenes; higher fatty acids such as a palmitin acid, a stearic acid, and an oleic acid; alcohols; sorbitan fatty acid esters; fatty acid modified polyesters; tertiary amine modified polyurethanes; and polyethyleneimines.

Since band gaps of quantum dots are increased as their size is decreased, the size is adjusted as appropriate so that light with a desired wavelength can be obtained. Light emission from the quantum dots is shifted to a blue color side, i.e., a high energy side, as the crystal size is decreased; thus, emission wavelengths of the quantum dots can be adjusted over wavelength regions of spectra of an ultraviolet region, a visible light region, and an infrared region by changing the size of quantum dots. The range of size (diameter) of quantum dots which is usually used is 0.5 nm to 20 nm, preferably 1 nm to 10 nm. The emission spectra are narrowed as the size distribution of the quantum dots gets smaller, and thus light can be obtained with high color purity. The shape of the quantum dots is not particularly limited and may be a spherical shape, a rod shape, a circular shape, or the like. Quantum rods which are rod-like shape quantum dots emit directional light polarized in the c-axis direction; thus, quantum rods can be used as a light-emitting material to obtain a light-emitting element with higher external quantum efficiency.

In most EL elements, to improve luminous efficiency, light-emitting materials are dispersed in host materials and the host materials need to be substances each having a singlet excitation energy or a triplet excitation energy higher than or equal to that of the light-emitting material. In the case of using a blue phosphorescent material, it is particularly difficult to develop a host material which has a triplet excitation energy higher than or equal to that of the blue phosphorescent material and which is excellent in terms of a lifetime. On the other hand, even when a light-emitting layer is composed of quantum dots and made without a host material, the quantum dots enable luminous efficiency to be ensured; thus, a light-emitting element which is favorable in terms of a lifetime can be obtained. In the case where the light-emitting layer is composed of quantum dots, the quantum dots preferably have core-shell structures (including core-multishell structures).

The conductive film that transmits visible light can be formed using, for example, indium oxide, indium tin oxide, indium zinc oxide, zinc oxide, or zinc oxide to which gallium is added. Alternatively, a film of a metal material such as gold, silver, platinum, magnesium, nickel, tungsten, chromium, molybdenum, iron, cobalt, copper, palladium, or titanium; an alloy containing any of these metal materials; or a nitride of any of these metal materials (e.g., titanium nitride) can be used when formed thin so as to have a light-transmitting property. Alternatively, a stacked film of any of the above materials can be used as the conductive layer. For example, a stacked film of indium tin oxide and an alloy of silver and magnesium is preferably used, in which case conductivity can be increased. Further alternatively, graphene or the like may be used.

For the conductive film that reflects visible light, for example, a metal material, such as aluminum, gold, platinum, silver, nickel, tungsten, chromium, molybdenum, iron, cobalt, copper, or palladium or an alloy including any of these metal materials can be used. Lanthanum, neodymium, germanium, or the like may be added to the metal material or the alloy. Alternatively, an alloy containing aluminum (an aluminum alloy) such as an alloy of aluminum and titanium, an alloy of aluminum and nickel, or an alloy of aluminum and neodymium may be used. Alternatively, an alloy containing silver such as an alloy of silver and copper, an alloy of silver and palladium, or an alloy of silver and magnesium may be used. An alloy of silver and copper is preferable because of its high heat resistance. Furthermore, when a metal film or a metal oxide film is stacked in contact with an aluminum film or an aluminum alloy film, oxidation can be suppressed. Examples of a material for the metal film or the metal oxide film include titanium and titanium oxide. Alternatively, the conductive film having a property of transmitting visible light and a film containing any of the above metal materials may be stacked. For example, a stacked film of silver and indium tin oxide, a stacked film of an alloy of silver and magnesium and indium tin oxide, or the like can be used.

The electrodes may be formed separately by an evaporation method or a sputtering method. Alternatively, a discharging method such as an inkjet method, a printing method such as a screen printing method, or a plating method may be used.

### [Adhesive Layer]

As the adhesive layer, a variety of curable adhesives such as a reactive curable adhesive, a thermosetting adhesive, an anaerobic adhesive, and a photocurable adhesive such as an ultraviolet curable adhesive can be used. Examples of these adhesives include an epoxy resin, an acrylic resin, a silicone resin, a phenol resin, a polyimide resin, an imide resin, a polyvinyl chloride (PVC) resin, a polyvinyl butyral (PVB) resin, and an ethylene vinyl acetate (EVA) resin. In particular, a material with low moisture permeability, such as an epoxy resin, is preferred. Alternatively, a two-component-mixture-type resin may be used. Further alternatively, an adhesive sheet or the like may be used.

Furthermore, the resin may include a drying agent. For example, a substance that adsorbs moisture by chemical adsorption, such as oxide of an alkaline earth metal (e.g., calcium oxide or barium oxide), can be used. Alternatively, a substance that adsorbs moisture by physical adsorption, such as zeolite or silica gel, may be used. The drying agent is preferably included because it can suppress entry of impurities such as moisture into the element, thereby improving the reliability of the display panel.

In addition, it is preferable to mix a filler with a high refractive index or light-scattering member into the resin, in which case light extraction efficiency can be increased. For example, titanium oxide, barium oxide, zeolite, zirconium, or the like can be used.

### [Connection Layer]

As the connection layers, an anisotropic conductive film (ACF), an anisotropic conductive paste (ACP), or the like can be used.

### [Coloring Layer]

Examples of a material that can be used for the coloring layers include a metal material, a resin material, and a resin material containing a pigment or dye.

### [Light-Blocking Layer]

Examples of a material that can be used for the light-blocking layer include carbon black, titanium black, a metal, a metal oxide, and a composite oxide containing a solid solution of a plurality of metal oxides. The light-blocking layer may be a film containing a resin material or a thin film of an inorganic material such as a metal. Stacked films containing the material of the coloring layer can also be used for the light-blocking layer. For example, a stacked-layer structure of a film containing a material of a coloring layer which transmits light of a certain color and a film containing a material of a coloring layer which transmits light of another color can be employed. It is preferable that the coloring layer and the light-blocking layer be formed using the same material because the same manufacturing apparatus can be used and the process can be simplified.

The above is the description of the components.

### [Modification Example]

Structure examples which partly differ from the display device described in the above cross-sectional structure example will be described below. Note that the description of the portions already described above is omitted and only different portions are described.

### [Modification Example 1 of Cross-Sectional Structure Example]

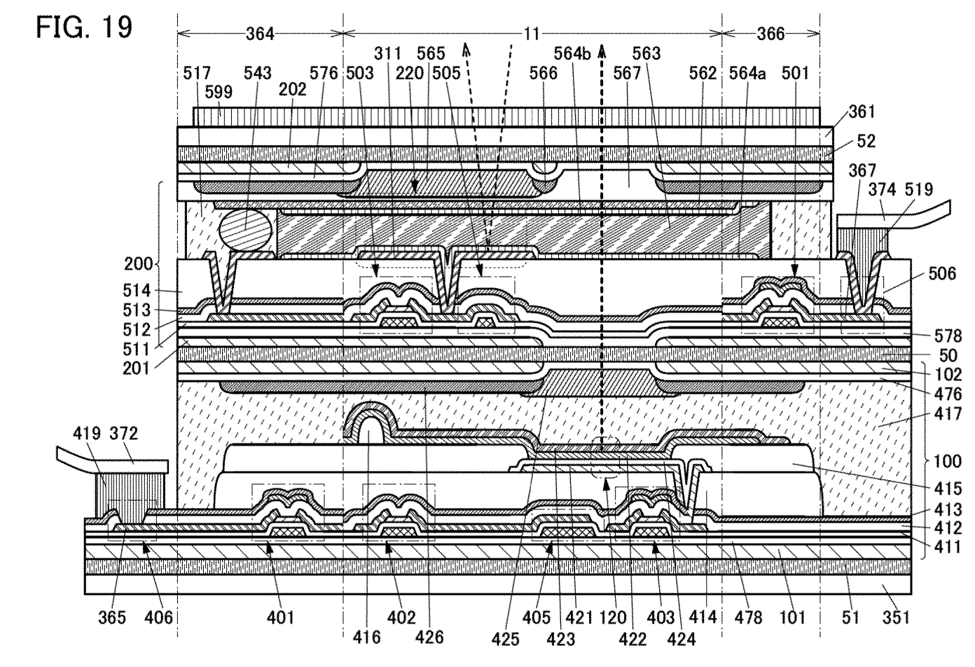

FIG. 19 is different from FIG. 18 in the structures of transistors and the resin layer 202 and in that a coloring layer 565, a light-blocking layer 566, and an insulating layer 567 are provided.

The transistor 401, the transistor 403, and the transistor 501 illustrated in FIG. 19 each include a second gate electrode. In this manner, a transistor including a pair of gates is preferably used as each of the transistors provided in the circuit portion 364 and the circuit portion 366 and the transistor that controls current flowing to the light-emitting element 120.

In the resin layer 202, an opening overlapping with the liquid crystal element 220 and an opening overlapping with the light-emitting element 120 are separately formed, whereby the reflectance of the liquid crystal element 220 can be increased.

The light-blocking layer 566 and the coloring layer 565 are provided on a surface of the insulating layer 576 on the liquid crystal element 220 side. The coloring layer 565 is provided so as to overlap with the liquid crystal element 220. Thus, the display panel 200 can perform color display. The light-blocking layer 566 has an opening overlapping with the liquid crystal element 220 and an opening overlapping with the light-emitting element 120. This allows fabrication of a display device that suppresses mixing of colors between adjacent pixels and thus has high color reproducibility.

### [Modification Example 2 of Cross-Sectional Structure Example]

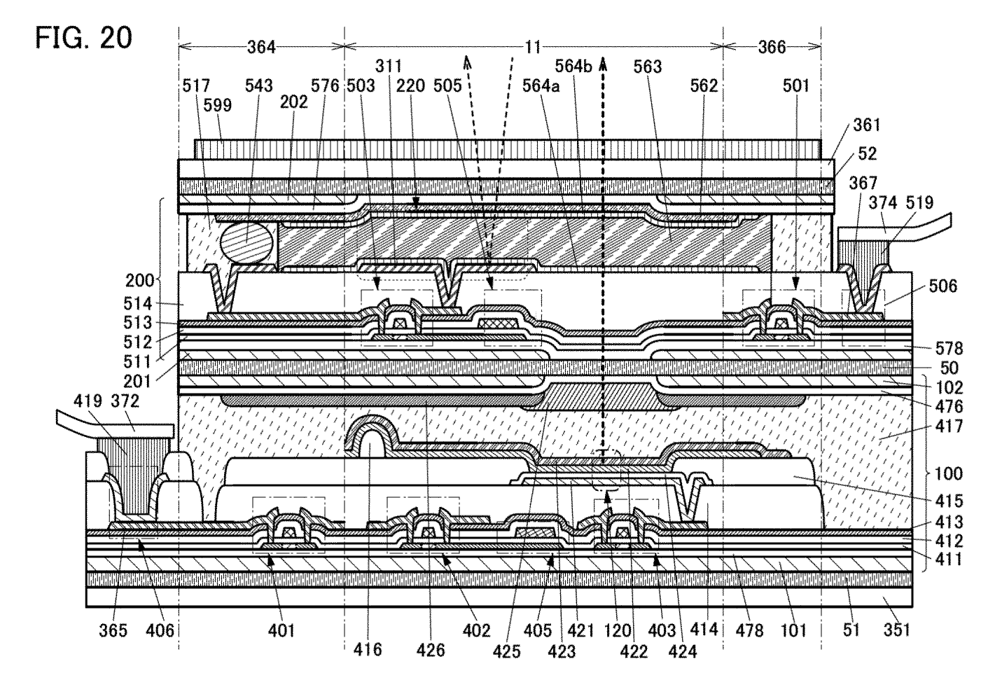

FIG. 20 illustrates an example in which a top-gate transistor is used as each transistor. The use of a top-gate transistor can reduce parasitic capacitance, leading to an increase in the frame frequency of display. Furthermore, a top-gate transistor can favorably be used for a large display panel with a size of 8 inches or more.

### [Modification Example 3 of Cross-Sectional Structure Example]

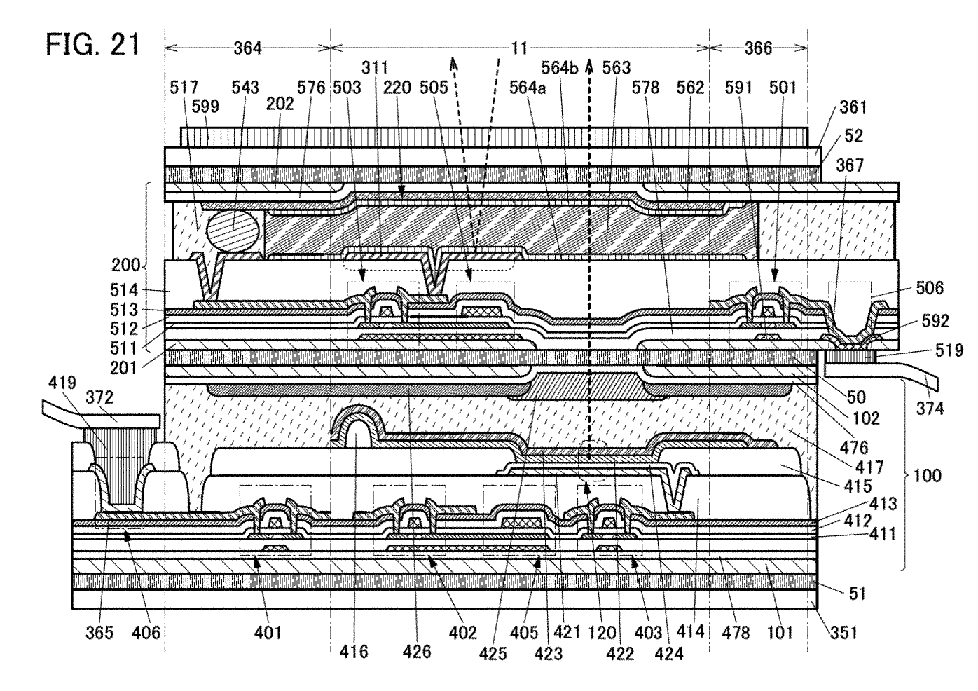

FIG. 21 illustrates an example in which a top-gate transistor including a second gate electrode is used as each transistor.

Each of the transistors includes a conductive layer 591 over the resin layer 101 or the resin layer 201. The insulating layer 411 or the insulating layer 578 is provided so as to cover the conductive layer 591.

In the connection portion 506 of the display panel 200, an opening is formed in part of the resin layer 201, and a conductive layer 592 is provided so as to fill the opening. The conductive layer 592 is provided such that the back surface (a surface on the display panel 100 side) thereof is exposed. The conductive layer 592 is electrically connected to the wiring 367. The FPC 374 is electrically connected to the exposed surface of the conductive layer 592 through the connection layer 519. The conductive layer 592 can be formed by processing the conductive film with which the conductive layer 591 is formed. The conductive layer 592 functions as an electrode that can also be called a back electrode.

Such a structure can be obtained by using a photosensitive organic resin for the resin layer 201. For example, in forming the resin layer 201 over a support substrate, an opening is formed in the resin layer 201 and the conductive layer 592 is formed so as to fill the opening. When the resin layer 201 and the support substrate are separated from each other, the conductive layer 592 and the support substrate are also separated from each other, whereby the conductive layer 592 illustrated in FIG. 21 can be formed. For example, the following method can be used: a method of using a light-absorbing layer or a method of forming a rein layer having a depressed portion or a resin layer having a two-layer structure and then etching part of the resin layer to expose the rear surface of the conductive layer 592.

Such a structure allows the FPC 374 connected to the display panel 200 located on the display surface side to be positioned on the side opposite to the display surface. Thus, a space for bending the FPC 374 in incorporating a display device in an electronic device can be eliminated, which enables the electronic device to be smaller.

The above is the description of the modification examples.

At least part of this embodiment can be implemented in combination with any of the other embodiments described in this specification as appropriate.

### Embodiment 4

### [Composition of CAC-OS]

Described below is the composition of a cloud aligned composite oxide semiconductor (CAC-OS) applicable to a transistor disclosed in one embodiment of the present invention.

The CAC-OS has, for example, a composition in which elements included in an oxide semiconductor are unevenly distributed. Materials including unevenly distributed elements each have a size of greater than or equal to 0.5 nm and less than or equal to 10 nm, preferably greater than or equal to 1 nm and less than or equal to 2 nm, or a similar size. Note that in the following description of an oxide semiconductor, a state in which one or more metal elements are unevenly distributed and regions including the metal element(s) are mixed is referred to as a mosaic pattern or a patch-like pattern. The region has a size of greater than or equal to 0.5 nm and less than or equal to 10 nm, preferably greater than or equal to 1 nm and less than or equal to 2 nm, or a similar size.

Note that an oxide semiconductor preferably contains at least indium. In particular, indium and zinc are preferably contained. In addition, aluminum, gallium, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like may be contained.

For example, of the CAC-OS, an In—Ga—Zn oxide with the CAC composition (such an In—Ga—Zn oxide may be particularly referred to as CAC-IGZO) has a composition in which materials are separated into indium oxide (InO_{X1}, where X1 is a real number greater than 0) or indium zinc oxide (In_{X2}Zn_{Y2}O_{Z2}, where X2, Y2, and Z2 are real numbers greater than 0), and gallium oxide (GaO_{X3}, where X3 is a real number greater than 0) or gallium zinc oxide (Ga_{X4}Zn_{Y4}O_{Z4}, where X4, Y4, and Z4 are real numbers greater than 0), and a mosaic pattern is formed. Then, InO_{X1} or In_{X2}Zn_{Y2}O_{Z2} forming the mosaic pattern is evenly distributed in the film. This composition is also referred to as a cloud-like composition.

That is, the CAC-OS is a composite oxide semiconductor with a composition in which a region including GaO_{X3} as a main component and a region including In_{X2}Zn_{Y2}O_{X2} or InO_{X1} as a main component are mixed. Note that in this specification, for example, when the atomic ratio of In to an element M in a first region is greater than the atomic ratio of In to an element M in a second region, the first region has higher In concentration than the second region.

Note that a compound including In, Ga, Zn, and O is also known as IGZO. Typical examples of IGZO include a crystalline compound represented by InGaO₃(ZnO)ₘ₁ (m1 is a natural number) and a crystalline compound represented by In₍₁₊ₓ₀₎Ga₍₁₋ₓ₀₎O₃(ZnO)ₘ₀ (−1≦x0≦1; m0 is a given number).

The above crystalline compounds have a single crystal structure, a polycrystalline structure, or a CAAC structure. Note that the CAAC structure is a crystal structure in which a plurality of IGZO nanocrystals have c-axis alignment and are connected in the a-b plane direction without alignment.

On the other hand, the CAC-OS relates to the material composition of an oxide semiconductor. In a material composition of a CAC-OS including In, Ga, Zn, and O, nanoparticle regions including Ga as a main component are observed in part of the CAC-OS and nanoparticle regions including In as a main component are observed in part thereof. These nanoparticle regions are randomly dispersed to form a mosaic pattern. Therefore, the crystal structure is a secondary element for the CAC-OS.

Note that in the CAC-OS, a stacked-layer structure including two or more films with different atomic ratios is not included. For example, a two-layer structure of a film including In as a main component and a film including Ga as a main component is not included.

A boundary between the region including GaO_{X3} as a main component and the region including In_{X2}Zn_{Y2}O_{X2} or InO_{X1} as a main component is not clearly observed in some cases.

In the case where one or more of aluminum, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like are contained instead of gallium in a CAC-OS, nanoparticle regions including the selected metal element(s) as a main component(s) are observed in part of the CAC-OS and nanoparticle regions including In as a main component are observed in part thereof, and these nanoparticle regions are randomly dispersed to form a mosaic pattern in the CAC-OS.

The CAC-OS can be formed by a sputtering method under conditions where a substrate is not heated intentionally, for example. In the case of forming the CAC-OS by a sputtering method, one or more selected from an inert gas (typically, argon), an oxygen gas, and a nitrogen gas may be used as a deposition gas. The ratio of the flow rate of an oxygen gas to the total flow rate of the deposition gas at the time of deposition is preferably as low as possible, and for example, the flow ratio of an oxygen gas is preferably higher than or equal to 0% and less than 30%, further preferably higher than or equal to 0% and less than or equal to 10%.

The CAC-OS is characterized in that no clear peak is observed in measurement using θ/2θ scan by an out-of-plane method, which is an X-ray diffraction (XRD) measurement method. That is, X-ray diffraction shows no alignment in the a-b plane direction and the c-axis direction in a measured region.

In an electron diffraction pattern of the CAC-OS which is obtained by irradiation with an electron beam with a probe diameter of 1 nm (also referred to as a nanometer-sized electron beam), a ring-like region with high luminance and a plurality of bright spots in the ring-like region are observed. Therefore, the electron diffraction pattern indicates that the crystal structure of the CAC-OS includes a nanocrystal (nc) structure with no alignment in plan-view and cross-sectional directions.

For example, an energy dispersive X-ray spectroscopy (EDX) mapping image confirms that an In—Ga—Zn oxide with the CAC composition has a structure in which a region including GaO_{X3} as a main component and a region including In_{X2}Zn_{Y2}O_{Z2} or InO_{X1} as a main component are unevenly distributed and mixed.

The CAC-OS has a structure different from that of an IGZO compound in which metal elements are evenly distributed, and has characteristics different from those of the IGZO compound. That is, in the CAC-OS, regions including GaO_{X3} or the like as a main component and regions including In_{X2}Zn_{Y2}O_{X2} or InO_{X1} as a main component are separated to form a mosaic pattern.

The conductivity of a region including In_{X2}Zn_{Y2}O_{Z2} or InO_{X1} as a main component is higher than that of a region including GaO_{X3} or the like as a main component. In other words, when carriers flow through regions including In_{X2}Zn_{Y2}O_{Z2} or InO_{X1} as a main component, the conductivity of an oxide semiconductor is generated. Accordingly, when regions including In_{X2}Zn_{Y2}O_{X2} or InO_{X1} as a main component are distributed in an oxide semiconductor like a cloud, high field-effect mobility (μ) can be achieved.

In contrast, the insulating property of a region including GaO_{X3} or the like as a main component is higher than that of a region including In_{X2}Zn_{Y2}O_{Z2} or InO_{X1} as a main component. In other words, when regions including GaO_{X3} or the like as a main component are distributed in an oxide semiconductor, leakage current can be suppressed and favorable switching operation can be achieved.

Accordingly, when a CAC-OS is used for a semiconductor element, the insulating property derived from GaO_{X3} or the like and the conductivity derived from In_{X2}Zn_{Y2}O_{Z2} or InO_{X1} complement each other, whereby high on-state current (Iₒₙ) and high field-effect mobility (μ) can be achieved.

A semiconductor element including a CAC-OS has high reliability. Thus, the CAC-OS is suitably used in a variety of semiconductor devices typified by a display.

At least part of this embodiment can be implemented in combination with any of the other embodiments described in this specification as appropriate.

### Embodiment 5

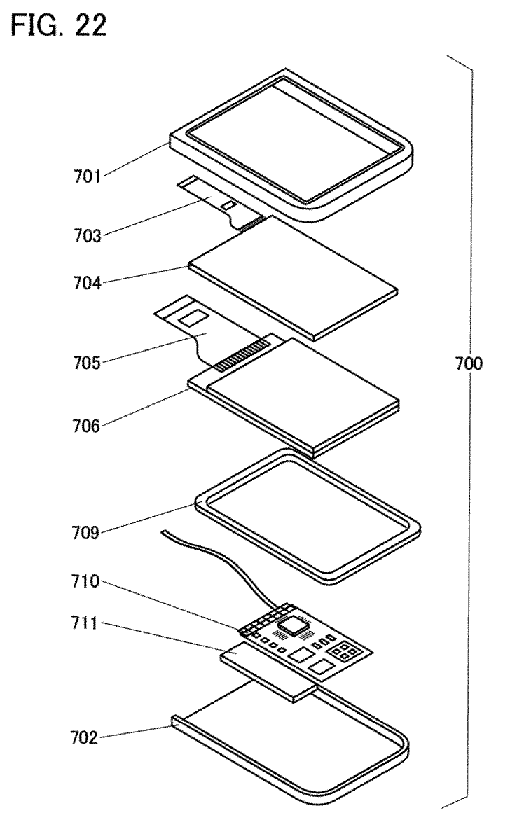

In this embodiment, a display module that can be fabricated using one embodiment of the present invention will be described with reference to FIG. 22.

In a display module 700 in FIG. 22, a touch panel 704 connected to an FPC 703, a display panel 706 connected to an FPC 705, a frame 709, a printed circuit board 710, and a battery 711 are provided between an upper cover 701 and a lower cover 702.

The display device of one embodiment of the present invention can be used for, for example, the display panel 706. Accordingly, a high-quality image can be displayed with low power consumption.

The shapes and sizes of the upper cover 701 and the lower cover 702 can be changed as appropriate in accordance with the sizes of the touch panel 704 and the display panel 706.

The touch panel 704 can be a resistive touch panel or a capacitive touch panel and may be formed to overlap with the display panel 706. Instead of providing the touch panel 704, the display panel 706 can have a touch panel function.

The frame 709 protects the display panel 706 and functions as an electromagnetic shield for blocking electromagnetic waves generated by the operation of the printed circuit board 710. The frame 709 may also function as a radiator plate.

The printed circuit board 710 has a power supply circuit and a signal processing circuit for outputting a video signal and a clock signal. As a power source for supplying power to the power supply circuit, an external commercial power source or a power source using the battery 711 provided separately may be used. The battery 711 can be omitted in the case of using a commercial power source.

The display module 700 may be additionally provided with a member such as a polarizing plate, a retardation plate, or a prism sheet.

At least part of this embodiment can be implemented in combination with any of the other embodiments described in this specification as appropriate.

### Embodiment 6

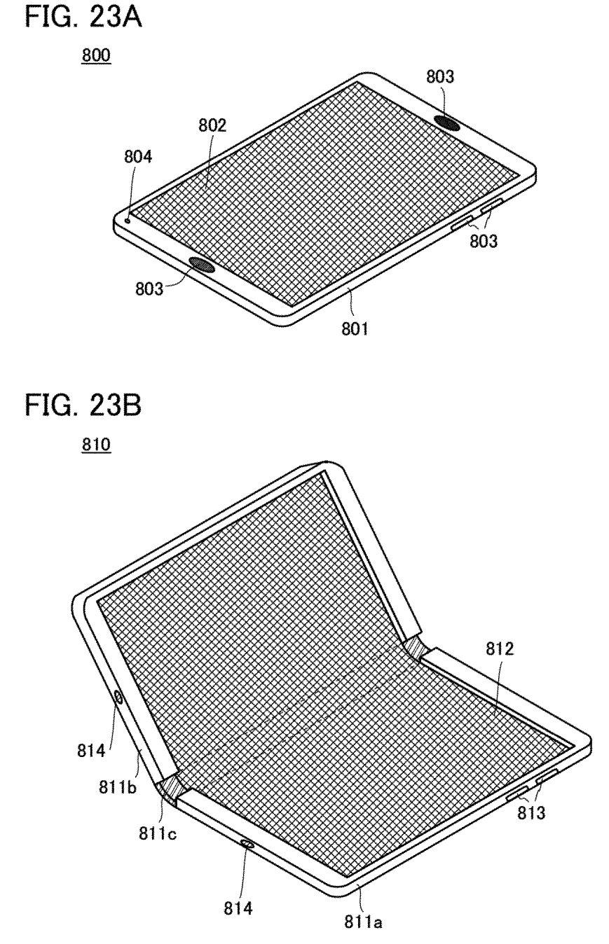

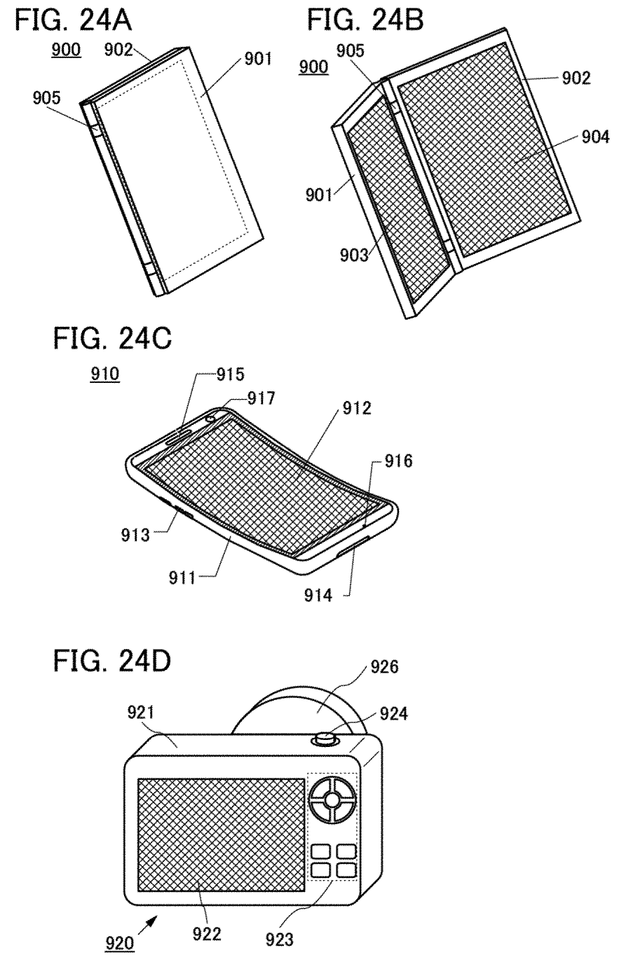

In this embodiment, electronic devices to which the display device of one embodiment of the present invention can be applied are described with reference to FIGS. 23A and 23B and FIGS. 24A to 24D.

FIG. 23A illustrates a tablet information terminal 800, which includes a housing 801, a display portion 802, operation buttons 803, and a speaker 804. A display device with a position input function may be used as the display portion 802. Note that the position input function can be added by provision of a touch panel in a display device, for example. Alternatively, the position input function can be added by providing a photoelectric conversion element in the display portion 802. As the operation buttons 803, any of a power switch for starting the information terminal 800, a button for operating an application of the information terminal 800, a volume control button, a switch for turning on or off the display portion 802, and the like can be provided. Although the number of the operation buttons 803 is four in the information terminal 800 illustrated in FIG. 23A, the number and position of operation buttons included in the information terminal 800 is not limited to this example.

Although not illustrated, the information terminal 800 illustrated in FIG. 23A may include a microphone in addition to the speaker. The information terminal 800 with this structure can have a telephone function like a cellular phone, for example.

Although not illustrated, the information terminal 800 illustrated in FIG. 23A may include a camera. Although not illustrated, the information terminal 800 illustrated in FIG. 23A may include a light-emitting device for use as a flashlight or a lighting device.

Although not illustrated, the information terminal 800 illustrated in FIG. 23A includes, in the housing 801, the sensor 13 described in Embodiment 1. The infrared source 21 described in Embodiment 1 may be included in the housing 801. A sensor (a sensor having a function of measuring force, displacement, position, speed, acceleration, angular velocity, rotational frequency, distance, liquid, magnetism, temperature, chemical substance, sound, time, hardness, electric field, current, voltage, electric power, radiation, flow rate, humidity, gradient, oscillation, odor, or the like) may be included in the housing 801. In particular, when a sensing device including a sensor for detecting inclination, such as a gyroscope sensor or an acceleration sensor is provided, display on the screen of the display portion 802 can be automatically changed in accordance with the orientation of the information terminal 800 illustrated in FIG. 23A by determining the orientation of the information terminal 800 (the orientation of the information terminal with respect to the vertical direction).

Although not illustrated, the information terminal 800 illustrated in FIG. 23A may include a device for obtaining biological information such as fingerprints, veins, iris, voice prints, or the like. With this structure, the information terminal 800 can have a biometric identification function.

Although not illustrated, the information terminal 800 illustrated in FIG. 23A may include a microphone. With this structure, the information terminal 800 can have a telephone function. In some cases, the information terminal 800 can have a speech interpretation function. With the speech interpretation function, the information terminal 800 can have a function of operating the information terminal 800 by speech recognition, a function of interpreting a speech or a conversation and creating a summary of the speech or the conversation, and the like. This can be utilized to create meeting minutes or the like, for example.

For the display portion 802, a flexible base may be used. Specifically, the display portion 802 may have a structure in which a transistor, capacitor, a display element, and the like are formed over the flexible base. With such a structure, in addition to the information terminal 800 having the housing 801 with a flat surface as illustrated in FIG. 23A, an electronic device having a housing with a curved surface can be achieved.

Furthermore, a flexible base may be used for the display portion 802 of the information terminal 800 so that the display portion 802 is freely foldable. FIG. 23B illustrates such a structure. An information terminal 810 is a tablet information terminal similar to the information terminal 800 and includes a housing 811a, a housing 811b, a display portion 812, operation buttons 813, and speakers 814.

The housing 811a and the housing 811b are connected to each other with a hinge portion 811c that allows the display portion 812 to be folded in half. The display portion 812 is provided in the housing 811a and the housing 811b and over the hinge portion 811c.

As a flexible base that can be used for the display portion 802, any of the following materials that transmit visible light can be used: a poly(ethylene terephthalate) resin (PET), a poly(ethylene naphthalate) resin (PEN), a poly(ether sulfone) resin (PES), a polyacrylonitrile resin, an acrylic resin, a polyimide resin, a poly(methyl methacrylate) resin, a polycarbonate resin, a polyamide resin, a polycycloolefin resin, a polystyrene resin, a poly(amide imide) resin, a polypropylene resin, a polyester resin, a poly(vinyl halide) resin, an aramid resin, an epoxy resin, or the like. Alternatively, a mixture or a stack including any of these materials may be used.

The information terminal 800 or the information terminal 810 that includes the display device of one embodiment of the present invention can display a high-quality image with low power consumption.

FIGS. 24A and 24B illustrate an example of an information terminal 900. The information terminal 900 includes a housing 901, a housing 902, a display portion 903, a display portion 904, and a hinge 905, for example. Although not illustrated, the sensor 13 described in Embodiment 1 is included in the housing 901 and/or the housing 902. The infrared source 21 described in Embodiment 1 may be included in the housing 901 and/or the housing 902.

The housing 901 and the housing 902 are joined together with the hinge 905. The information terminal 900 can be changed from a folded state illustrated in FIG. 24A to an opened state illustrated in FIG. 24B.

For example, text information can be displayed on the display portion 903 and the display portion 904; thus, the information terminal 900 can be used as an e-book reader. For example, the information terminal 900 can be used as a textbook. The display portion 903 and the display portion 904 each can display a still image or a moving image.

In this manner, the information terminal 900 has high versatility because it can be folded when carried.

Note that the housing 901 and the housing 902 may have a power button, an operation button, an external connection port, a speaker, a microphone, and the like.

The information terminal 900 that includes the display device of one embodiment of the present invention can display a high-quality image with low power consumption.

FIG. 24C shows an example of the information terminal. An information terminal 910 shown in FIG. 24C includes a housing 911, a display portion 912, an operation button 913, an external connection port 914, a speaker 915, a microphone 916, and a camera 917, for example. Although not illustrated, the sensor 13 described in Embodiment 1 is included in the housing 911. The infrared source 21 described in Embodiment 1 may be included in the housing 911.

The information terminal 910 includes a touch sensor in the display portion 912. Moreover, operations such as making a call and inputting a letter can be performed by touch on the display portion 912 with a finger, a stylus, or the like.

The power can be turned on or off with the operation button 913. In addition, types of images displayed on the display portion 912 can be switched; for example, switching images from a mail creation screen to a main menu screen is performed with the operation button 913.

When a detection device such as a gyroscope sensor or an acceleration sensor is provided inside the information terminal 910, the direction of display on the screen of the display portion 912 can be automatically changed by determining the orientation of the information terminal 910 (whether the information terminal 910 is placed horizontally or vertically). Furthermore, the direction of display on the screen can be changed by touch on the display portion 912, operation with the operation button 913, sound input using the microphone 916, or the like.

The information terminal 910 has one or more of a telephone function, a notebook function, an information browsing function, and the like, for example. Specifically, the information terminal can be used as a smartphone. The information terminal 910 is capable of executing a variety of applications such as mobile phone calls, e-mailing, viewing and editing texts, music reproduction, video replay, Internet communication, and games.

The information terminal 910 that includes the display device of one embodiment of the present invention can display a high-quality image with low power consumption.

FIG. 24D illustrates an example of a camera. A camera 920 includes a housing 921, a display portion 922, operation buttons 923, and a shutter button 924, for example. Furthermore, an attachable/detachable lens 926 is attached to the camera 920. The sensor 13 described in Embodiment 1 is included in the housing 921. The infrared source 21 described in Embodiment 1 may be included in the housing 921.

Although the lens 926 of the camera 920 here is detachable from the housing 921 for replacement, the lens 926 may be included in the housing.

Still and moving images can be taken with the camera 920 at the press of the shutter button 924. In addition, images can be taken at the touch of the display portion 922 that serves as a touch panel.

Note that a stroboscope, a viewfinder, or the like can be additionally provided in the camera 920. Alternatively, these may be included in the housing 921.

The camera 920 that includes the display device of one embodiment of the present invention can display a high-quality image with low power consumption.

At least part of this embodiment can be implemented in combination with any of the other embodiments described in this specification as appropriate.

### REFERENCE NUMERALS

10: display device, 11: display portion, 11a: display portion, 11b: display portion, 12: pixel, 12a: pixel, 12b: pixel, 12B: subpixel, 12G: subpixel, 12R: subpixel, 13: sensor, 13a: sensor, 13b: sensor, 13c: sensor, 13d: sensor, 14: memory circuit, 15: arithmetic circuit, 17: source driver circuit, 18: gate driver circuit, 20a: part, 20b: part, 20c: part, 21: infrared source, 21a: infrared source, 21b: infrared source, 50: adhesive layer, 51: adhesive layer, 52: adhesive layer, 63: luminance, 64: luminance, 81: region, 82: region, 100: display panel, 101: resin layer, 102: resin layer, 110: transistor, 110a: transistor, 110b: transistor, 110c: transistor, 111: conductive layer, 112: semiconductor layer, 113a: conductive layer, 113b: conductive layer, 114: conductive layer, 115: conductive layer, 120: light-emitting element, 120B: light-emitting element, 120G: light-emitting element, 120R: light-emitting element, 121: conductive layer, 122: EL layer, 123: conductive layer, 131: insulating layer, 132: insulating layer, 133: insulating layer, 134: insulating layer, 135: insulating layer, 136: insulating layer, 137: insulating layer, 141: insulating layer, 151: adhesive layer, 152: coloring layer, 153: light-blocking layer, 200: display panel, 201: resin layer, 202: resin layer, 204: insulating layer, 210: transistor, 211: conductive layer, 212: semiconductor layer, 213a: conductive layer, 213b: conductive layer, 220: liquid crystal element, 220B: liquid crystal element, 220G: liquid crystal element, 220R: liquid crystal element, 221: conductive layer, 222: liquid crystal, 223: conductive layer, 224a: alignment film, 224b: alignment film, 231: insulating layer, 232: insulating layer, 233: insulating layer, 234: insulating layer, 255: luminance, 311: electrode, 351: substrate, 361: substrate, 364: circuit portion, 365: wiring, 366: circuit portion, 367: wiring, 372: FPC, 373: IC, 374: FPC, 375: IC, 401: transistor, 402: transistor, 403: transistor, 404: light-emitting element, 405: capacitor, 406: connection portion, 411: insulating layer, 412: insulating layer, 413: insulating layer, 414: insulating layer, 415: insulating layer, 416: spacer, 417: adhesive layer, 419: connection layer, 421: electrode, 422: EL layer, 423: electrode, 424: optical adjustment layer, 425: coloring layer, 426: light-blocking layer, 451: opening, 476: insulating layer, 478: insulating layer, 501: transistor, 503: transistor, 505: capacitor, 506: connection portion, 511: insulating layer, 512: insulating layer, 513: insulating layer, 514: insulating layer, 517: connection layer, 519: connection layer, 543: connector, 562: electrode, 563: liquid crystal, 564a: alignment film, 564b: alignment film, 565: coloring layer, 566: light-blocking layer, 567: insulating layer, 576: insulating layer, 578: insulating layer, 591: conductive layer, 592: conductive layer, 599: polarizing plate, 611: substrate, 612: substrate, 621: light, 622: reflected light, 700: display module, 701: upper cover, 702: lower cover, 703: FPC, 704: touch panel, 705: FPC, 706: display panel, 709: frame, 710: printed circuit board, 711: battery, 800: information terminal, 801: housing, 802: display portion, 803: operation button, 804: speaker, 810: information terminal, 811a: housing, 811b: housing, 811c: hinge, 812: display portion, 813: operation button, 814: speaker, 900: information terminal, 901: housing, 902: housing, 903: display portion, 904: display portion, 905: hinge, 910: information terminal, 911: housing, 912: display portion, 913: operation button, 914: external connection port, 915: speaker, 916: microphone, 917: camera, 920: camera, 921: housing, 922: display portion, 923: operation button, 924: shutter button, 926: lens.

This application is based on Japanese Patent Application Serial No. 2016-149266 filed with Japan Patent Office on Jul. 29, 2016 and Japanese Patent Application Serial No. 2016-149267 filed with Japan Patent Office on Jul. 29, 2016, the entire contents of which are hereby incorporated by reference.

1. A display method of a display device including a display portion where first pixels including light-emitting elements are arranged in matrix, wherein each of the first pixels comprises subpixels, comprising the steps of:
calculating a first part watched by a user of the display device; and
determining whether or not the first part is included in the display portion,
wherein, when the first part is included in the display portion, a gray level for representation of luminance of light emitted from first subpixels included in the first part is made different from a gray level for representation of luminance of light emitted from second subpixels that are not included in any of the first part and a part in a neighborhood of the first part.

2. The display method according to claim 1,
wherein a size and a shape of the part in the neighborhood of the first part is set depending on a size and a shape of the first part.

3. The display method according to claim 1, further comprising a step of detecting a pupil of the user of the display device using a sensor,
wherein the sensor is included in the display device.

4. The display method according to claim 1,
wherein the first part is calculated using a distance between the user of the display device and the display portion.

5. The display method according to claim 1,
wherein the display device includes a second pixel,
wherein the second pixel includes a liquid crystal element, and
wherein the second pixel is stacked over the first pixels.

6. The display method according to claim 1,
wherein each of the light-emitting elements is an OLED.

7. A display device configured to display an image by the display method according to claim 1.

8. The display device according to claim 7, further comprising a transistor and an infrared source.

9. The display device according to claim 8,
wherein the transistor includes a metal oxide in a channel formation region.

10. An electronic device comprising:
the display device according to claim 7; and
an operation button or a battery.

11. A non-temporary memory medium storing a program configured to execute the display method according to claim 1.

12. A display method of a display device including a display portion where first pixels including light-emitting elements are arranged in matrix, wherein each of the first pixels comprises subpixels, comprising the steps of:
calculating a first part watched by a user of the display device; and
calculating a row or a column of text included in the first part,
wherein a gray level for representation of luminance of light emitted from first subpixels provided in the row or the column of the text included in the first part is made different from a gray level for representation of luminance of light emitted from second subpixels provided in a row or a column that is not a row or a column of text included in the first part and is not a row or a column in a neighborhood of the row or the column of text included in the first part.

13. The display method according to claim 12,
wherein a row previous to the row of the text included in the first part and a row next to the row of the text included in the first part are defined as rows in a neighborhood of the row of the text included in the first part.

14. The display method according to claim 12,
wherein a column previous to the column of the text included in the first part and a column next to the column of the text included in the first part are defined as columns in a neighborhood of the column of the text included in the first part.

15. The display method according to claim 12, further comprising a step of detecting a pupil of the user of the display device using a sensor,
wherein the sensor is included in the display device.

16. The display method according to claim 12,
wherein the first part is calculated using a distance between the user of the display device and the display portion.

17. The display method according to claim 12,
wherein the display device includes a second pixel,
wherein the second pixel includes a liquid crystal element, and
wherein the second pixel is stacked over the first pixels.

18. The display method according to a claim 12,
wherein each of the light-emitting elements is an OLED.

19. A display device configured to display an image by the display method according to claim 12.

20. The display device according to claim 19, further comprising a transistor and an infrared source.

21. The display device according to claim 20,
wherein the transistor includes a metal oxide in a channel formation region.

22. An electronic device comprising:
the display device according to claim 19; and
an operation button or a battery.

23. A non-temporary memory medium storing a program configured to execute the display method according to claim 12.
